(19) United States
(12) Patent Application Publication
(10) Pub. No.: US 2019/0148986 A1
(43) Pub. Date: May 16, 2019

(54) METHOD AND APPARATUS FOR SWITCHING WIRELESS POWER TRANSMISSION MODE

(71) Applicant: LG INNOTEK CO., LTD., Seoul (KR)

(72) Inventors: Dong Han YOO, Seoul (KR); Yong Il KWON, Seoul (KR); Jae Kyu LEE, Seoul (KR)

(73) Assignee: LG Innotek Co., Ltd., Seoul (KR)

(21) Appl. No.: 16/097,010

(22) PCT Filed: Apr. 12, 2017
(86) PCT No.: PCT/KR2017/003935

§ 371 Date: Oct. 26, 2018

(30) Foreign Application Priority Data
May 31, 2016 (KR) 10-2016-0067378

(51) Int. Cl. H02J 50/40; H02J 50/12; H02J 7/02; H02J 50/80

(52) U.S. Cl. CPC H02J 50/40; H02J 50/80; H02J 7/025; H02J 50/12

(57) ABSTRACT

The present invention relates to a method and an apparatus for switching a wireless power transmission mode. According to one embodiment of the present invention, the method by which a multi-mode wireless power transmitter switches a wireless power transmission mode comprises the steps of: detecting a second wireless power receiver while transmitting the power to a first wireless power receiver; calculating second power transmission efficiency for the detected second wireless power receiver; and determining a final wireless power transmission mode by comparing the first power transmission efficiency for the first wireless power receiver with the second power transmission efficiency, wherein the multi-mode wireless power transmitter simultaneously transmits the power by using an electromagnetic induction mode and/or an electromagnetic resonance mode, and the second wireless power receiver can receive the power by using only one mode between the electromagnetic resonance mode and the electromagnetic induction mode at a time.

### TECHNICAL FIELD

Embodiments relate to wireless power transmission, and more particularly, to a method of switching a wireless power transmission mode.

### BACKGROUND ART

A portable terminal such as a cellular phone and a laptop computer includes a battery for storing power and a circuit for charging and discharging the battery. To charge the battery of such a terminal, the terminal needs to receive power from an external charger.

In general, an example of an electrical connection mode between a battery and a charging device for charging the battery with power includes a terminal supply mode of receiving commercial power, converting the commercial power into voltage and current corresponding to the battery, and supplying electrical energy to the battery through a terminal of the corresponding battery. The terminal supply mode is accompanied by use of a physical cable or wiring. Accordingly, when many equipments of the terminal supply mode are used, a significant working space is occupied by many cables, it is difficult to organize the cables, and an outer appearance is achieved. In addition, the terminal supply mode causes problems such as an instantaneous discharge phenomenon due to different potential differences between terminals, damage and fire due to impurities, natural discharge, and degradation in lifespan and performance of a battery.

Recently, to overcome the problems, a charging system (hereinafter, referred to as a “wireless charging system”) and control methods using a mode of wirelessly transmitting power have been proposed. In the past, a wireless charging system is not basically installed in some portable terminals and a consumer needs to purchase a separate accessory of a wireless charging receiver and, thus, a demand for a wireless charging system is low, but users of wireless charging are expected to be remarkably increased and, in the future, a terminal manufacturer is also expected to basically installed a wireless charging function.

In general, a wireless charging system includes a wireless power transmitter that supplies energy electrical energy in a wireless power transmission mode and a wireless power receiver that receives electrical energy supplied from the wireless power transmitter and charges a battery with the electrical energy.

The wireless charging system may transmit power in at least one wireless power transmission mode (e.g., an electromagnetic induction mode, an electromagnetic resonance mode, and a radio frequency (RF) wireless power transmission mode).

For example, the wireless power transmission mode may use various wireless power transmission standards based on an electromagnetic induction mode for performing charging using an electromagnetic induction principle whereby a power transmission end coil generates a magnetic field to induce electricity in a reception end coil by the influence of the magnetic field. Here, the wireless power transmission standard of the electromagnetic induction mode may include a wireless charging technology of an electromagnetic induction mode in the wireless power consortium (WPC) and/or the power matters alliance (PMA).

As another example, the wireless power transmission mode may use an electromagnetic resonance mode for transmitting power to a wireless power receiver positioned at a short distance via synchronization between a magnetic field generated by a transmission coil of a wireless power transmitter and a specific resonance frequency. Here, the electromagnetic resonance mode may include a wireless charging technology defined in the alliance for the wireless power (A4WP) standard institute that is a wireless charging technology standard institute.

As another example, the wireless power transmission mode may use an RF wireless power transmission mode for transmitting power to a wireless power receiver positioned at a long distance by delivering low power energy in an RF signal.

The wireless charging system may be designed to support at least two or more wireless power transmission modes of the electromagnetic induction mode, the electromagnetic resonance mode, and the RF wireless power transmission mode. In other words, the wireless power transmitter may be designed to transmit power to the wireless power receiver in a plurality of wireless power transmission modes.

The wireless power transmitter and the wireless power receiver are not forced to match with each other according to one to one correspondence. While transmitting power to the wireless power receiver, the wireless power transmitter also continues to search for another wireless power receiver and the wireless power transmitter also transmits power to a newly retrieved wireless power receiver.

When the wireless power transmitter does not attempt communication connection for power transmission with respect to the newly retrieved wireless power receiver, if a plurality of wireless power receivers is not capable of being simultaneously recharged and power transmission efficiency with respect to the newly retrieved wireless power receiver is high, power transmission is wholly inefficient.

Accordingly, there is a need for a detailed method of controlling an operation of a wireless power transmitter between a plurality of wireless power receivers when the wireless power transmitter searches for another wireless power receiver while transmitting power to any wireless power receiver in a specific wireless power transmission mode.

### DISCLOSURE

### Technical Problem

Embodiments provide a method and apparatus for switching a wireless power transmission mode.

The present disclosure provides a method of switching a wireless power transmission mode in consideration of power transmission efficiency and priority of each of an existing wireless power receiver that already receives power and a newly retrieved wireless power receiver by a wireless power transmitter and receiver in a wireless charging system for supporting an electromagnetic induction mode and an electromagnetic resonance mode.

It is to be understood that both the foregoing general description and the following detailed description of the present disclosure are exemplary and explanatory and are intended to provide further explanation of the present disclosure as claimed.

### Technical Solution

In one embodiment, a method of switching a wireless power transmission mode by a multiplex-mode wireless power transmitter includes detecting a second wireless power receiver during power transmission to a first wireless power receiver, calculating second power transmission efficiency with respect to the detected second wireless power receiver, and comparing first power transmission efficiency with respect to the first wireless power receiver and the second power transmission efficiency to determine a final wireless power transmission mode, wherein the multiplex-mode wireless power transmitter simultaneously transmits power in at least one mode of an electromagnetic induction mode and an electromagnetic resonance mode and the second wireless power receiver receives power in only any one of the electromagnetic resonance mode and the electromagnetic induction mode at one time.

In some embodiments, the comparing of the first power transmission efficiency with respect to the first wireless power receiver and the second power transmission efficiency to determine the final wireless power transmission mode may include determining the final wireless power transmission mode based on a comparison result of the first power transmission efficiency and the second power transmission efficiency and preset priority.

In some embodiments, the priority may be further increased as a remaining capacity of a battery of each of the first and second wireless power receivers is lowered.

In some embodiments, the priority may be increased as a battery reduction variation amount of each of the first and second wireless power receivers is increased.

In some embodiments, the comparing of the first power transmission efficiency with respect to the first wireless power receiver and the second power transmission efficiency to determine the wireless power transmission mode may include transmitting power to at least one of the first wireless power receiver and the second wireless power receiver in at least one of the electromagnetic induction mode and the electromagnetic resonance mode.

In some embodiments, the transmitting of power to at least one of the first wireless power receiver and the second wireless power receiver in at least one of the electromagnetic induction mode and the electromagnetic resonance mode may include terminating power transmission in the electromagnetic induction mode to the first wireless power receiver, and transmitting power to the first wireless power receiver and the second wireless power receiver in the electromagnetic resonance mode.

In some embodiments, the transmitting of power to at least one of the first wireless power receiver and the second wireless power receiver in at least one of the electromagnetic induction mode and the electromagnetic resonance mode may include transmitting power to the second wireless power receiver in the electromagnetic resonance mode while maintaining power transmission in the electromagnetic resonance mode to the first wireless power receiver.

In some embodiments, the transmitting of power to at least one of the first wireless power receiver and the second wireless power receiver in at least one of the electromagnetic induction mode and the electromagnetic resonance mode may include terminating power transmission to the first wireless power receiver and transmitting power to the second wireless power receiver in the electromagnetic induction mode.

In some embodiments, the transmitting of power to at least one of the first wireless power receiver and the second wireless power receiver in at least one of the electromagnetic induction mode and the electromagnetic resonance mode may include maintaining power transmission with respect to the first wireless power receiver and terminating a communication session for power transmission in the electromagnetic induction mode with respect to the second wireless power receiver.

In some embodiments, the method may further include calculating the first power transmission efficiency with respect to the first wireless power receiver while transmitting power to the first wireless power receiver.

In another embodiment, a method of switching a wireless power transmission mode by a multiplex-mode wireless power transmitter includes detecting a second wireless power receiver during power transmission to a first wireless power receiver, upon detecting the second wireless power receiver in an electromagnetic induction mode, and maintaining power transmission with respect to the first wireless power receiver and terminating a communication session for power transmission in an electromagnetic induction mode with respect to the second wireless power receiver, wherein the multiplex-mode wireless power transmitter simultaneously transmits power in at least one of the electromagnetic induction mode and the electromagnetic resonance mode.

In some embodiments, a computer readable recording medium having recorded thereon a program for executing the method may be provided.

In another embodiment, a multiplex-mode wireless power transmitter for simultaneously transmitting power in at least one mode of an electromagnetic induction mode and an electromagnetic resonance mode includes a detector for detecting a second wireless power receiver during power transmission to a first wireless power receiver, and a controller for calculating second power transmission efficiency with respect to the detected second wireless power receiver and comparing first power transmission efficiency with respect to the first wireless power receiver and the second power transmission efficiency to determine a final wireless power transmission mode, wherein the second wireless power receiver receives power in only any one of an electromagnetic resonance mode and an electromagnetic induction mode at one time.

In some embodiments, the controller may determine the final wireless power transmission mode based on a comparison result of the first power transmission efficiency with respect to the first wireless power receiver and the second power transmission efficiency and preset priority.

In some embodiments, the priority may be increased as a remaining capacity of a battery of each of the first and second wireless power receivers is lowered.

In some embodiments, the priority may be increased as a battery reduction variation amount of each of the first and second wireless power receivers is increased.

In some embodiments, the controller may transmit power to at least one of the first wireless power receiver and the second wireless power receiver in at least one of the electromagnetic induction mode and the electromagnetic resonance mode.

In some embodiments, the controller may terminate power transmission in the electromagnetic induction mode to the first wireless power receiver and may transmit power to the first wireless power receiver and the second wireless power receiver in the electromagnetic resonance mode.

In some embodiments, the controller may transmit power to the second wireless power receiver in the resonance mode while maintaining power transmission in the electromagnetic resonance mode to the first wireless power receiver.

In some embodiments, the controller may terminate power transmission to the first wireless power receiver and may transmit power to the second wireless power receiver in the electromagnetic induction mode.

In some embodiments, wherein the controller may maintain power transmission with respect to the first wireless power receiver and may terminate a communication session for power transmission in the electromagnetic induction mode with respect to the second wireless power receiver.

In some embodiments, the controller may calculate the first power transmission efficiency with respect to the first wireless power receiver while transmitting power to the first wireless power receiver.

In another embodiment, a multiplex-mode wireless power transmitter for simultaneously transmitting power in at least one mode of an electromagnetic induction mode and an electromagnetic resonance mode includes a detector for detecting a second wireless power receiver during power transmission to a first wireless power receiver, and a controller for maintaining power transmission with respect to the first wireless power receive and terminating a communication session for power transmission in the electromagnetic induction mode with respect to the second wireless power receiver upon detecting the second wireless power receiver in the electromagnetic induction mode.

### Advantageous Effects

A method and apparatus for switching a wireless power transmission mode according to the present disclosure may have the following effect.

First, the present disclosure may select a wireless power transmission mode with high efficiency depending on a situation using a plurality of wireless power transmission modes to enhance transmission efficiency.

Second, the present disclosure may define a detailed communication rule for switching a wireless power transmission mode while using the disclosed wireless power transmission standard.

Third, the present disclosure may simultaneously supply power to a plurality of wireless charging receivers to enhance overall power transmission efficiency.

Fourth, the present disclosure may provide a method of determining a wireless power transmission mode in consideration of priority such as the remaining capacity of a battery of a wireless power receiver as well as power transmission efficiency to transmit optimum power depending on a situation.

It will be appreciated by persons skilled in the art that that the effects that could be achieved with embodiments are not limited to what has been particularly described hereinabove and other advantages of the present disclosure will be more clearly understood from the following detailed description taken in conjunction with the accompanying drawings.

### DESCRIPTION OF DRAWINGS

The accompanying drawings, which are included to provide a further understanding of embodiments, illustrate embodiments of the present disclosure and together with the description serve to explain the principle of the present disclosure.

FIG. 1 is a block diagram for explanation of a structure of a wireless power transmission system according to an embodiment of the disclosure.

FIG. 2 is an equivalent circuit diagram of a wireless power transmission system according to an embodiment of the disclosure.

FIG. 3 is a state transition diagram for explanation of a state transition procedure of a wireless power transmitter using an electromagnetic resonance mode according to an embodiment of the disclosure.

FIG. 4 is a state transition diagram of a wireless power receiver using an electromagnetic resonance mode according to an embodiment of the disclosure.

FIG. 5 is a diagram for explanation of an operating region of a wireless power receiver using an electromagnetic resonance mode depending on V_{RECT} according to an embodiment of the disclosure.

FIG. 6 is a flowchart for explanation of a wireless charging procedure using an electromagnetic resonance mode according to an embodiment of the disclosure.

FIG. 7 is a state transition diagram for explanation of a wireless power transmission procedure of an electromagnetic induction mode according to an embodiment of the present disclosure.

FIG. 8 is a diagram for explanation of a packet format depending on a wireless power transmission procedure of an electromagnetic induction mode according to an embodiment of the present disclosure.

FIG. 9 is a diagram for explanation of a type of a packet to be transmissible in a ping phase by a wireless power reception apparatus depending on a wireless power transmission procedure in an electromagnetic induction mode according to an embodiment of the present disclosure;

FIG. 10 is a diagram for explanation of a message format of an identification packet depending on a wireless power transmission procedure of an electromagnetic induction mode according to an embodiment of the present disclosure.

FIG. 11 is a diagram for explanation of a message format of a configuration packet and a power control hold-off packet depending on a wireless power transmission procedure of an electromagnetic induction mode according to an embodiment of the present disclosure.

FIG. 12 is a diagram for explanation of a type of a packet that is to be transmitted in a power transfer phase by a wireless power reception apparatus and a message format of the packet depending on a wireless power transmission procedure of an electromagnetic induction mode according to an embodiment of the present disclosure.

FIG. 13 is a flowchart for explanation of a method of switching a power transmission mode by a multiplex-mode wireless power transmitter according to an embodiment of the present disclosure.

FIG. 14 is a flowchart for explanation of the number of cases depending on a wireless power transmission mode in a method of switching a power transmission mode by a wireless power transmitter of a multiplex-mode wireless power transmitter according to an embodiment of the present disclosure.

FIG. 15 is a flowchart for explanation of a method of switching a power transmission mode by a multiplex-mode wireless power transmitter when a wireless power receiver in an electromagnetic resonance mode is detected during power transmission in an electromagnetic resonance mode according to an embodiment of the present disclosure.

FIG. 16 is a flowchart for explanation of a method of switching a power transmission mode by a multiplex-mode wireless power transmitter when a wireless power receiver in an electromagnetic induction mode is retrieved during power transmission based on an electromagnetic resonance mode according to an embodiment of the present disclosure.

FIG. 17 is a flowchart for explanation of a method of switching a power transmission mode by a multiplex-mode wireless power transmitter when a wireless power receiver in an electromagnetic induction mode is retrieved during power transmission in an electromagnetic induction mode according to an embodiment of the present disclosure.

FIG. 18 is a flowchart for explanation of a method of switching a power transmission mode by a multiplex-mode wireless power transmitter when a wireless power receiver in an electromagnetic resonance mode is received during power transmission in an electromagnetic induction mode according to an embodiment of the present disclosure.

### BEST MODE

A method of switching a wireless power transmission mode by a multiplex-mode wireless power transmitter according to an embodiment may include detecting a second wireless power receiver during power transmission to a first wireless power receiver, calculating second power transmission efficiency with respect to the detected second wireless power receiver, and comparing first power transmission efficiency with respect to the first wireless power receiver and the second power transmission efficiency to determine a final wireless power transmission mode, wherein the multiplex-mode wireless power transmitter may simultaneously transmit power in at least one mode of an electromagnetic induction mode and an electromagnetic resonance mode and the second wireless power receiver may receive power in only any one of the electromagnetic resonance mode and the electromagnetic induction mode at one time.

### Mode for Invention

Hereinafter, devices and various methods, to which embodiments of the present disclosure are applied, will be described in more detail with reference to the accompanying drawings. The suffixes “module” and “unit” of elements herein are used for convenience of description and thus can be used interchangeably and do not have any distinguishable meanings or functions.

Although all elements constituting the embodiments of the present disclosure are described as integrated into a single one or to be operated as a single one, the present disclosure is not necessarily limited to such embodiments. According to the present disclosure, all of the elements may be selectively integrated into one or more and be operated as one or more within the scope of the present disclosure. Each of the elements may be implemented as independent hardware. Alternatively, some or all of the elements may be selectively combined into a computer program having a program module performing some or all functions combined in one or more pieces of hardware. Code and code segments constituting the computer program may be easily understood by those skilled in the art to which the present disclosure pertains. The computer program may be stored in computer readable media such that the computer program is read and executed by a computer to implement the present disclosure. Computer program storage media may include magnetic recording media, optical recording media, and carrier wave media.

In description of exemplary embodiments, it will be understood that, when an element is referred to as being “on” or “under” and “before” or “after” another element, the element can be directly on another element or intervening elements may be present.

The terms “comprises”, “includes”, and “has” described herein should be interpreted not to exclude other elements but to further include such other elements since the corresponding elements may be included unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings in the related art from the context. Unless differently defined in the present disclosure, such terms should not be interpreted in an ideal or excessively formal manner.

It will be understood that, although the terms first, second, A, B, (a), (b), etc. may be used herein to describe various elements of the present disclosure, these terms are only used to distinguish one element from another element and essential, order, or sequence of corresponding elements are not limited by these terms. It will be understood that when one element is referred to as being “connected to”, “coupled to”, or “access” another element, one element may be “connected to”, “coupled to”, or “access” another element via a further element although one element may be directly connected to or directly access another element.

In the description of the present disclosure, certain detailed explanations of related art are omitted when it is deemed that they may unnecessarily obscure the essence of the present disclosure.

In the following description of the present disclosure, for convenience of description, an apparatus for wirelessly transmitting power in a wireless power charging system may be used interchangeably with a wireless power transmitter, a wireless power transmission apparatus, a wireless power transmission device, a transmission end, a transmitter, a transmission apparatus, a transmission side, a wireless charging apparatus, etc. In addition, for convenience of description, an apparatus for wirelessly receiving power from a wireless power transmission apparatus may be used interchangeably with a wireless power reception apparatus, a wireless power receiver, a wireless power reception device, a reception terminal, a reception side, a reception apparatus, a receiver terminal, etc.

A wireless charging apparatus according to the present disclosure may be configured in the form of a pad, a cradle, an access point (AP), a small base station, a stand, a ceiling insert type, a wall-hanging type, a vehicle insert type, a vehicle mount type, or the like. One transmitter may simultaneously transmit power to a plurality of wireless power reception apparatuses.

For example, a wireless power transmitter is generally put and used on a desk, a table, or the like and is also developed and applied to a vehicle and is used in the vehicle. A wireless power transmitter installed in a vehicle is provided in the form of a cradle to be simply and stably fixed and supported.

A terminal according to the present disclosure may be mounted on a small-size electronic apparatus such as a mobile phone, a smartphone, a laptop, a digital broadcasting terminal, a personal digital assistants (PDA), a portable multimedia player (PMP), a navigation system, an MP3 player, an electric toothbrush, a radio frequency identification (RFID) tag, an illumination apparatus, a remote controller, and a bobber, without being limited thereto. Accordingly, the terminal according to the present disclosure may be any mobile device (hereinafter, referred to as a “device”) that includes a wireless power reception element according to the present disclosure is installed therein and includes a rechargeable battery and may be interchangeably used with a terminal or a device. A wireless power receiver according to another embodiment of the present disclosure may also be installed in a vehicle, an unmanned aerial vehicle, an AR. drone, a robot, and so on.

A wireless power receiver according to an embodiment of the present disclosure may use at least one wireless power transmission mode and may also simultaneously and wirelessly receive power from two or more wireless power transmitters. Here, the wireless power transmission mode may include at least one of the electromagnetic induction mode, the electromagnetic resonance mode, and the RF wireless power transmission mode.

In general, a wireless power transmitter and a wireless power receiver, which are included in a wireless power system, may exchange a control signal or information via in-band communication or Bluetooth low energy (BLE) communication. Here, in-band communication and BLE communication may be performed using a pulse width modulation mode, a frequency modulation mode, a phase modulation mode, an amplitude modulation mode, an amplitude and phase modulation mode, or the like. For example, the wireless power receiver may ON/OFF switch current induced through a reception coil in a predetermined pattern to generate a feedback signal and, thus, may transmit various control signals and information to the wireless power transmitter. Information transmitted by the wireless power receiver may include various state information items including reception power intensity information. In this case, the wireless power transmitter may calculate charging efficiency or power transmission efficiency based on reception power intensity information.

According to another embodiment of the present disclosure, the wireless power transmitter according to the present disclosure may also be designed to support at least two or more wireless power transmission modes of the electromagnetic induction mode, the electromagnetic resonance mode, and the RF wireless power transmission mode.

Thereamong, the wireless power transmission mode for supporting the electromagnetic induction mode and the electromagnetic resonance mode is defined as a multiplex-mode wireless power transmission mode. An operation in a channel of each wireless power transmission mode for supporting the multiplex-mode wireless power transmission mode may each be performed depending on the electromagnetic induction mode and the electromagnetic resonance mode.

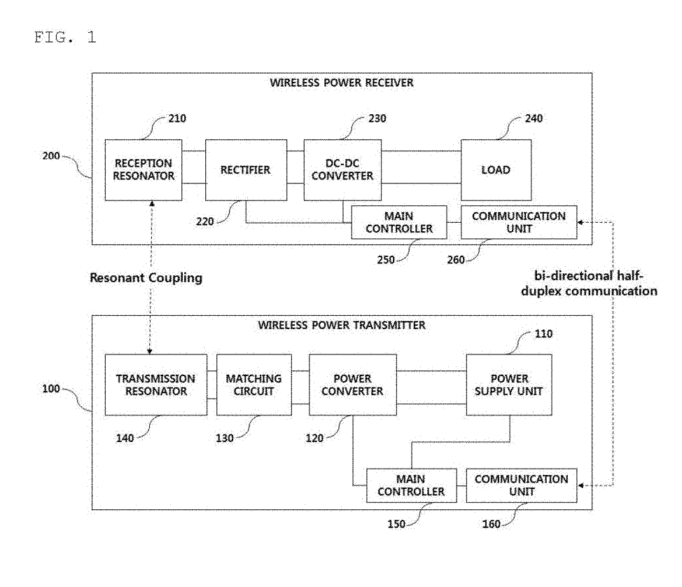

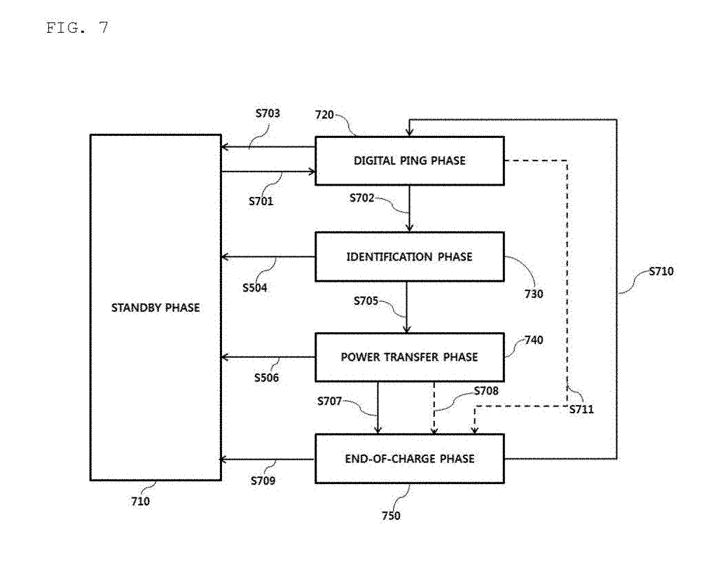

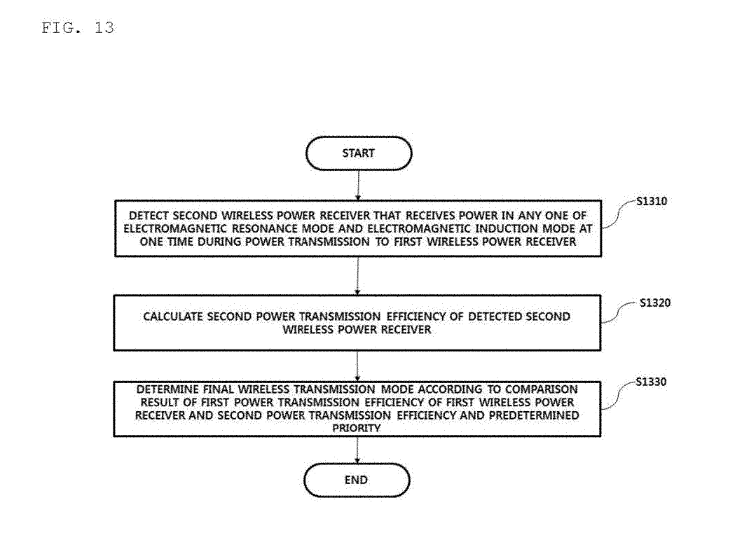

Hereinafter, the electromagnetic resonance mode of the wireless power transmission mode is described with reference to FIGS. 1 to 6 and the electromagnetic induction mode is described with reference to FIGS. 7 to 12. Then, a method of switching the wireless power transmission mode between the electromagnetic induction mode and electromagnetic resonance mode by a multiplex-mode wireless power transmitter is described with reference to FIGS. 13 to 18.

FIG. 1 is a block diagram for explanation of a structure of a wireless power transmission system according to an embodiment of the disclosure.

Referring to FIG. 1, the wireless power transmission system may include a wireless power transmitter 100 and a wireless power receiver 200.

Although FIG. 1 illustrates the case in which the wireless power transmitter 100 wirelessly transmits power to one wireless power receiver 200, this is merely an embodiment and, thus, according to another embodiment of the disclosure, the wireless power transmitter 100 may wirelessly transmit power to a plurality of wireless power receivers 200. It is noted that, according to another embodiment of the disclosure, the wireless power receiver 200 may wirelessly and simultaneously receive power from a plurality of wireless power transmitters 100.

The wireless power transmitter 100 may generate a magnetic field using a specific power transmission frequency and transmit power to the wireless power receiver 200.

The wireless power receiver 200 may receive power in synchronization with the same frequency as a frequency used by the wireless power transmitter 100.

For example, a frequency used for power transmission may be a band of 6.78 MHz, without being limited thereto.

That is, power transmitted by the wireless power transmitter 100 may be transmitted to the wireless power receiver 200 that resonates with the wireless power transmitter 100.

A maximum number of wireless power receivers 200 capable of receiving power from one wireless power transmitter 100 may be determined based on a maximum transmission power level of the wireless power transmitter 100, a maximum power reception level of the wireless power receiver 200, and physical structures of the wireless power transmitter 100 and the wireless power receiver 200.

The wireless power transmitter 100 and the wireless power receiver 200 may perform bi-directional communication with a different frequency band from a frequency for wireless power transmission, i.e. a resonance frequency band. For example, the bi-directional communication may use a half-duplex Bluetooth low energy (BLE) communication protocol.

The wireless power transmitter 100 and the wireless power receiver 200 may exchange each other's characteristics and state information, i.e. power negotiation information through the bi-directional communication.

For example, the wireless power receiver 200 may transmit predetermined power reception state information for controlling a level of power received from the wireless power transmitter 100 to the wireless power transmitter 100 through bi-directional communication, and the wireless power transmitter 100 may dynamically control a transmitted power level based on the received power reception state information. As such, the wireless power transmitter 100 may optimize power transmission efficiency and may also perform a function of preventing a load from being damaged due to over voltage, a function of preventing unnecessary power from being wasted due to under voltage, and so on.

The wireless power transmitter 100 may perform a function of authenticating and identifying the wireless power receiver 200 through bi-directional communication, a function of identifying an incompatible apparatus or a non-rechargeable object, a function for identifying a valid load, and so on.

Hereinafter, a wireless power transmission procedure of a resonance mode will be described in more detail with reference to FIG. 1.

The wireless power transmitter 100 may include a power supply 110, a power converter 120, a matching circuit 130, a transmission resonator 140, a main controller 150, and a communicator 160. The communicator 160 may include a data transmitter and a data receiver.

The power supply 110 may apply a specific voltage to the power converter 120 under control of the main controller 150. In this case, the applied voltage may be a DC voltage or an AC voltage.

The power converter 120 may convert a voltage received from the power supply 110 into a specific voltage under control of the main controller 150. To this end, the power converter 120 may include at least one of a DC/DC convertor, an AC/DC convertor, and a power amplifier.

The matching circuit 130 may be a circuit for matching impedance between the power converter 120 and the transmission resonator 140 in order to maximize power transmission efficiency.

The transmission resonator 140 may wirelessly transmit power using a specific resonance frequency according to a voltage applied from the matching circuit 130.

The wireless power receiver 200 may include a reception resonator 210, a rectifier 220, a DC-DC converter 230, a load 240, a main controller 250, and a communicator 260. The communicator 260 may include a data transmitter and a data receiver.

The reception resonator 210 may receive power transmitted by the transmission resonator 140 through a resonance phenomenon.

The rectifier 220 may perform a function of converting an AC voltage applied from the reception resonator 210 into a DC voltage.

The DC-DC converter 230 may convert the rectified DC voltage into a specific DC voltage required by the load 240.

The main controller 250 may control operations of the rectifier 220 and the DC-DC converter 230 or may generate the characteristics and state information of the wireless power receiver 200 and may control the communicator 260 to transmit the characteristics and state information of the wireless power receiver 200 to the wireless power transmitter 100. For example, the main controller 250 may monitor output voltages and current intensity of the rectifier 220 and the DC-DC converter 230 and control operations of the rectifier 220 and the DC-DC converter 230.

Information on the monitored output voltages and current intensity may be transmitted to the wireless power transmitter 100 through the communicator 260 in real time.

The main controller 250 may compare the rectified DC voltage with a predetermined reference voltage to determine whether a current state is an over-voltage state or an under-voltage state, and upon detecting a system error state as the determination result, the main controller 250 may transmit the detection result to the wireless power transmitter 100 through the communicator 260.

Upon detecting a system error state, the main controller 250 may control operations of the rectifier 220 and the DC-DC converter 230 or control power supplied to the load 240 using a predetermined over current cutoff circuit including a switch and/or a Zener diode in order to prevent a load from being damaged.

Although FIG. 1 illustrates the case in which the main controller 150 or 250 and the communicator 160 or 260 are configured as different modules, this is merely an embodiment and, thus, according to another embodiment of the disclosure, it is noted that the main controller 150 or 250 and the communicator 160 or 260 may be configured as one module.

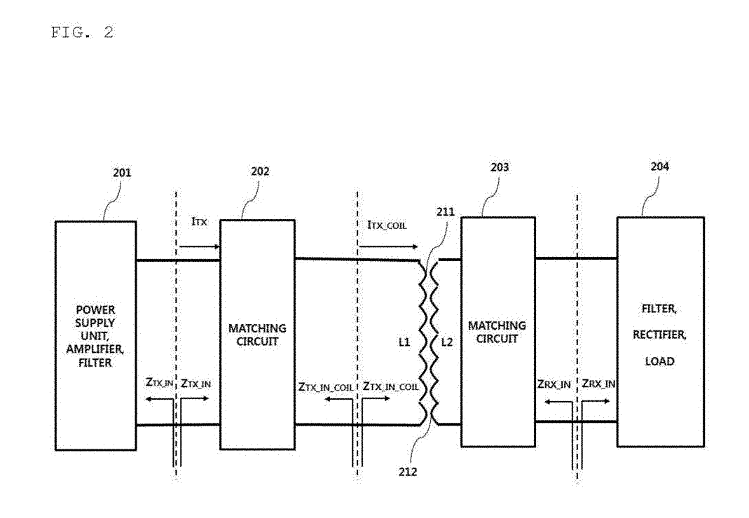

FIG. 2 is an equivalent circuit diagram of a wireless power transmission system according to an embodiment of the disclosure.

In detail, FIG. 2 illustrates an interface point in an equivalent circuit for measuring reference parameters to be described below.

Hereinafter, the meaning of reference parameters illustrated in FIG. 2 will be described briefly.

I_{TX} and I_{TX}_{_}_{COIL} may refer to root mean square (RMS) current supplied to a matching circuit (or matching network) 220 of the wireless power transmitter and RMS current supplied to a transmission resonator coil 225 of the wireless power transmitter, respectively.

Z_{TX}_{_}_{IN} and Z_{TX}_{_}_{IN}_{_}_{COIL} may refer to input impedance of a front end of the matching circuit 220 of the wireless power transmitter and input impedance of a rear end of the matching circuit 220 and a front end of the transmission resonator coil 225, respectively.

L1 and L2 may refer to an inductance value of the transmission resonator coil 225 and an inductance value of a reception resonator coil 227, respectively.

Z_{RX}_{_}_{IN} may refer to input impedance of a rear end of a matching circuit 230 of a wireless power receiver and a front end of a filter/rectifier/load 240.

According to an embodiment of the disclosure, a resonance frequency used in an operation of a wireless power transmission system may be 6.78 MHz±15 kHz.

In addition, a wireless power transmission system according to an embodiment of the disclosure may provide simultaneous charging, i.e. multi-charging, to a plurality of wireless power receivers, and in this case, even if a new wireless power receiver is added or a wireless power receiver is removed, a reception power variation amount of a maintained wireless power receiver may be controlled not to exceed a predetermined reference value or more. For example, a reception power variation amount may be, without being limited to, ±10%.

According to a condition for maintaining the reception power variation amount, a wireless power receiver that is added to a charging area or is removed may not overlap with an existing wireless power receiver.

When the matching circuit 230 of the wireless power receiver is connected to a rectifier, a real part of Z_{TX}_{_}_{IN} may have an inverse relationship with load resistance of a rectifier (hereinafter, referred to as R_{RECT}). That is, increase in R_{RECT} may reduce Z_{TX}_{_}_{IN} and reduction in R_{RECT} may increase Z_{TX}_{_}_{IN}.

According to the disclosure, resonator coupling efficiency may be a maximum power reception ratio calculated by dividing power transmitted to the load 240 from a reception resonator coil by power carried in a resonance frequency band by the transmission resonator coil 225. Resonator coupling efficiency between the wireless power transmitter and the wireless power receiver may be calculated when reference port impedance Z_{TX}_{_}_{IN} of a transmission resonator and a reference port impedance Z_{RX}_{_}_{IN} of a reception resonator are completely matched with each other.

Table 1 below shows an example of minimum resonator coupling efficiency according to a class of a wireless power transmitter and a class of a wireless power receiver according to an embodiment of the disclosure.

TABLE 1

| | Category 1 | Category 2 | Category 3 | Category 4 | Category 5 | Category 6 | Category 7 |
|---|---|---|---|---|---|---|---|
| Class 1 | N/A | N/A | N/A | N/A | N/A | N/A | N/A |
| Class 2 | N/A | 74%(−1.3) | 74%(−1.3) | N/A | N/A | N/A | N/A |
| Class 3 | N/A | 74%(−1.3) | 74%(−1.3) | 76%(−1.2) | N/A | N/A | N/A |
| Class 4 | N/A | 50%(−3) | 65%(−1.3) | 73%(−1.4) | 76%(−1.2) | N/A | N/A |
| Class 5 | N/A | 40%(−4) | 60%(−2.2) | 63%(−2) | 73%(−1.4) | 76%(−1.2) | N/A |
| Class 5 | N/A | 30%(−5.2) | 50%(−3) | 54%(−2.7) | 63%(−2) | 73%(−1.4) | 76%(−1.2) |

When a plurality of wireless power receivers is used, minimum resonator coupling efficiency corresponding to class and category shown in Table 1 above may be increased.

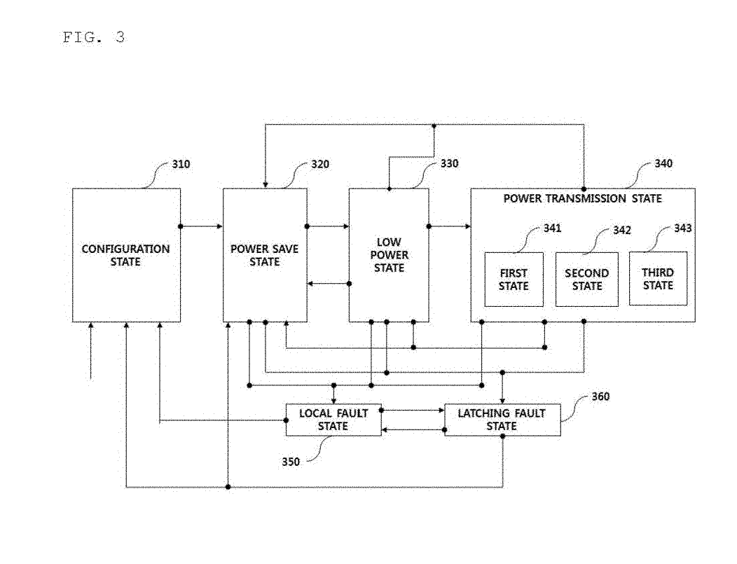

FIG. 3 is a state transition diagram for explanation of a state transition procedure of a wireless power transmitter using an electromagnetic resonance mode according to an embodiment of the disclosure.

Referring to FIG. 3, a state of the wireless power transmitter may roughly include a configuration state 310, a power save state 320, a low power state 330, a power transfer state 340, a local fault state 350, and a latching fault state 360.

When power is supplied to a wireless power transmitter, the wireless power transmitter may transition to the configuration state 310. The wireless power transmitter may transition to the power save state 320 when a predetermined reset timer expires or an initialization procedure is completed in the configuration state 310.

In the power save state 320, the wireless power transmitter may generate a beacon sequence and transmit the beacon sequence through a resonance frequency band.

Here, the wireless power transmitter may perform control to enter the power save state 320 and to initiate the beacon sequence within a predetermined time. For example, the wireless power transmitter may perform control to initialize the beacon sequence within 50 ms after transition to the power save state 320, without being limited thereto.

In the power save state 320, the wireless power transmitter may periodically generate and transmit a first beacon sequence for detection of the wireless power receiver and may detect impedance variation of a reception resonator, i.e. load variation. Hereinafter, for convenience of description, a first beacon and a first beacon sequence will be referred to as a short beacon or a short beacon sequence, respectively.

In particular, the short beacon sequence may be repeatedly generated and transmitted with a predetermined time interval t_{CYCLE} for a short period t_{SHORT}_{_}_{BEACON} so as to save standby power of the wireless power transmitter before the wireless power receiver is detected. For example, t_{SHORT}_{_}_{BEACON} may be set to 30 ms or less and t_{CYCLE} may be set to 250 ms±5 ms. In addition, current intensity of a short beacon may be a predetermined reference value or more and may be gradually increased for a predetermined time. For example, minimum current intensity of a short beacon may be set to be sufficiently high so as to detect a wireless power receiver of Category 2 or more of Table 1.

According to the disclosure, a wireless power transmitter may include a predetermined sensing element for detection of change in reactance and resistance by a reception resonator according to a short beacon.

In addition, in the power save state 320, the wireless power transmitter may periodically generate and transmit a second beacon sequence for supplying sufficient power required for booting and response of the wireless power receiver. Hereafter, for convenience of description, the second beacon and the second beacon sequence will be referred to as a long beacon and a long beacon sequence, respectively.

That is, when booting is completed through a second beacon sequence, the wireless power receiver may broadcast a predetermined response signal through an out-of-band communication channel.

In particular, the long beacon sequence may be generated and transmitted with a predetermined time interval t_{LONG}_{_}_{BEACON}_{_}_{PERIOD} for a relatively long period compared with a short beacon in order to supply sufficient power required for booting of the wireless power receiver. For example, t_{LONG}_{_{—hd BEACON}} may be set to 105 ms+5 ms, t_{LONG}_{_}_{BEACON}_{_}_{PERIOD} may be set to 850 ms, and current intensity of a long beacon may be relatively high compared with current intensify of the short beacon. In addition, the long beacon may be maintained with power of predetermined intensity during a transmission period.

Then, the wireless power transmitter may be on standby to receive a predetermined response signal during a transmission period of the long beacon after detecting change in impedance of a reception resonator. Hereinafter, for convenience of description, the response signal will be referred to as an advertisement signal. Here, the wireless power receiver may broadcast the advertisement signal through a different out-of-band communication frequency band from a resonance frequency band.

For example, the advertisement signal may include at least one or any one of message identification information for identifying a message defined in a corresponding out-of-band communication standard, unique service or wireless power receiver identification information for identifying whether a wireless power receiver is a proper receiver or a compatible receiver to a corresponding wireless power transmitter, output power information of a wireless power receiver, information on rated voltage/current applied to a load, antenna gain information of a wireless power receiver, information for identifying a category of a wireless power receiver, authentication information of a wireless power receiver, information on whether an over voltage protection function is installed, and version information of software installed in a wireless power receiver.

Upon receiving an advertisement signal, the wireless power transmitter may transition to the low power state 330 from the power save state 320 and, then, may establish an out-of-band communication link with a wireless power receiver. Continuously, the wireless power transmitter may perform a registration procedure to a wireless power receiver through the established out-of-band communication link. For example, when out-of-band communication is Bluetooth low-power communication, the wireless power transmitter may perform Bluetooth pairing with the wireless power receiver and the transmitter and the receiver exchange at least one of state information, characteristics information, and control information with each other through the paired Bluetooth link.

When the wireless power transmitter transmits a predetermined control signal, i.e. a predetermined control signal for requesting a wireless power receiver to transmit power to a load, for initializing charging through out-of-band communication in the low power state 330 to the wireless power receiver, the wireless power transmitter may transition to the power transfer state 340 from the low power state 330.

When an out-of-band communication link establishment procedure or registration procedure is not normally completed in the low power state 330, the wireless power transmitter may transition to the power save state 320 from the low power state 330.

The wireless power transmitter may drive a separately divided link expiration timer for connection with each wireless power receiver and the wireless power receiver needs to transmit a predetermined message indicating that the receiver is present to the wireless power transmitter with a predetermined time before the link expiration timer expires. The link expiration timer may be reset whenever the message is received and an out-of-band communication link established between the wireless power receiver and the wireless power receiver may be maintained when the link expiration timer does not expire.

When all link expiration timers corresponding to out-of-band communication links established between a wireless power transmitter and at least one wireless power receiver expire in the low power state 330 or the power transfer state 340, the wireless power transmitter may transition to the power save state 320.

Upon receiving a valid advertisement signal from the wireless power receiver, the wireless power transmitter in the low power state 330 may drive a predetermined registration timer. In this case, when a registration timer expires, a wireless power transmitter in the low power state 330 may transition to the power save state 320. In this case, the wireless power transmitter may output a predetermined notification signal indicating registration failure through a notification display element, e.g. including an LED lamp, a display screen, and a beeper, included in the wireless power transmitter.

When all connected wireless power receivers are completely charged in the power transfer state 340, the wireless power transmitter may transition to the low power state 330.

In particular, the wireless power receiver may permit registration of a new wireless power receiver in the remaining states except for the configuration state 310, the local fault state 350, and the latching fault state 360.

In addition, the wireless power transmitter may dynamically control transmitted power based on state information received from the wireless power receiver in the power transfer state 340.

In this case, receiver state information transmitted to the wireless power transmitter from the wireless power receiver may include at least one of required power information, information on voltage and/or current measured at a rear end of a rectifier, charging state information, information for announcing over current, over voltage, and/or overheating states, and information indicating whether an element for shutting off or reducing power transmitted to a load is activated according to over current or over voltage. In this case, the receiver state information may be transmitted at a predetermined period or may be transmitted whenever a specific event occurs. In addition, the element for shutting off or reducing power transmitted to a load according over current or over voltage may be provided using at least one of an ON/OFF switch and a Zener diode.

According to another embodiment of the disclosure, the receiver state information transmitted to the wireless power transmitter from the wireless power receiver may further include at least one of information indicating that external power is connected to the wireless power receiver by wire and information indicating that an out-of-band communication mode is changed, e.g. near field communication (NFC) may be changed to Bluetooth low energy (BLE) communication.

According to another embodiment of the disclosure, a wireless power transmitter may adaptively determine intensity of power to be received for each wireless power receiver based on at least one of current available power of the wireless power transmitter, priority for each wireless power receiver, and the number of connected wireless power receivers. Here, the intensity of power to be transmitted for each wireless power receiver may be determined as a ratio for receiving power based on maximum power to be processed by a rectifier of a corresponding wireless power receiver.

Then, the wireless power transmitter may transmit a predetermined power adjustment command containing information on the determined power intensity to the corresponding wireless power receiver. In this case, the wireless power receiver may determine whether power is capable of being controlled in the power intensity determined by the wireless power transmitter and may transmit the determination result to the wireless power transmitter through a predetermined power adjustment response message.

According to another embodiment of the disclosure, the wireless power receiver may transmit predetermined receiver state information indicating whether wireless power adjustment is possible according to the power adjustment command of the wireless power transmitter prior to reception of the power adjustment command.

The power transfer state 340 may be any one of a first state 341, a second state 342, and a third state 343 according to a power reception state of a connected wireless power receiver.

For example, the first state 341 may refer to a state in which power reception states of all wireless power receivers connected to the wireless power transmitter are each a normal voltage state.

The second state 342 may refer to a state in which a power reception state of at least one wireless power receiver connected to the wireless power transmitter is a low voltage state and a wireless power receiver of a high voltage, state is not present.

The third state 343 may refer to a state in which a power reception state of at least one wireless power receiver connected to the wireless power transmitter is a high voltage state.

Upon detecting system error in the power save state 320, the low power state 330, or the power transfer state 340, the wireless power transmitter may transition to the latching fault state 360.

Upon determining that all connected wireless power receivers are removed from a charging region, the wireless power transmitter in the latching fault state 360 may transition to the configuration state 310 or the power save state 320.

In addition, upon detecting local fault in the latching fault state 360, the wireless power transmitter may transition to the local fault state 350. Here, when local fault is released, the wireless power transmitter in the local fault state 350 may re-transition to the latching fault state 360.

On the other hand, when the wireless power transmitter transitions to the local fault state 350 from any one of the configuration state 310, the power save state 320, the low power state 330, and the power transfer state 340 to the local fault state 350, if local fault is released, the wireless power transmitter may transition to the configuration state 310.

When the wireless power transmitter transitions to the local fault state 350, power supplied to the wireless power transmitter may be shut off. For example, upon detecting fault such as over voltage, over current, and overheating, the wireless power transmitter may transition to the local fault state 350, without being limited thereto.

For example, upon detecting over voltage, over current, overheating, or the like, the wireless power transmitter may transmit a predetermined power adjustment command for reducing intensity of power received by the wireless power receiver to at least one connected wireless power receiver.

As another example, upon detecting over voltage, over current, overheating, or the like, the wireless power transmitter may transmit a predetermined control command for stopping charging of the wireless power receiver to at least one connected wireless power receiver.

Through the aforementioned power adjustment procedure, the wireless power transmitter may prevent a device from being damaged due to over voltage, over current, overheating, or the like.

When intensity of output current of a transmission resonator is a reference value or more, the wireless power transmitter may transition to the latching fault state 360. In this case, the wireless power transmitter having transitioned to the latching fault state the latching fault state 360 may attempt to adjust the intensity of the output current of the transmission resonator to a reference value or less for a predetermined time. Here, the attempt may be repeatedly performed a predetermined number of times. Despite repeated performance, when the latching fault state 360 is not released, the wireless power transmitter may transmit a predetermined notification signal indicating that the latching fault state 360 is not released, to a user using a predetermined notification element. In this case, when all wireless power receivers positioned in the charging region of the wireless power transmitter are removed by the user, the latching fault state 360 may be released.

On the other hand, when intensity of output current of a transmission resonator is reduced to a reference value or less within a predetermined time or the intensity of output current of the transmission resonator is reduced to a reference value or less during the predetermined repeated performance, the latching fault state 360 may be automatically released, and in this case, the wireless power transmitter may automatically transition to the power save state 320 from the latching fault state 360 and may re-perform detection and identification procedures on the wireless power receiver.

The wireless power transmitter in the power transfer state 340 may transmit consecutive power and may adaptively control the transmitted power based on state information of the wireless power receiver and a predefined optimal voltage region setting parameter.

For example, the optimal voltage region setting parameter may include at least one of a parameter for identifying a low voltage region, a parameter for identifying an optimal voltage region, a parameter for identifying a high voltage region, and a parameter for identifying an over voltage region.

When a power reception state of the wireless power receiver is in a low voltage region, the wireless power transmitter may increase transmitted power, and when the power reception state is in a high voltage region, the wireless power transmitter may reduce transmitted power.

The wireless power transmitter may control transmitted power to maximize power transmission efficiency.

The wireless power transmitter may control transmitted power such that a deviation of a power amount required by the wireless power receiver is a reference value or less.

In addition, when an output voltage of a rectifier of a wireless power receiver reaches a predetermined over voltage region, i.e. when an over voltage is detected, the wireless power transmitter may stop power transmission

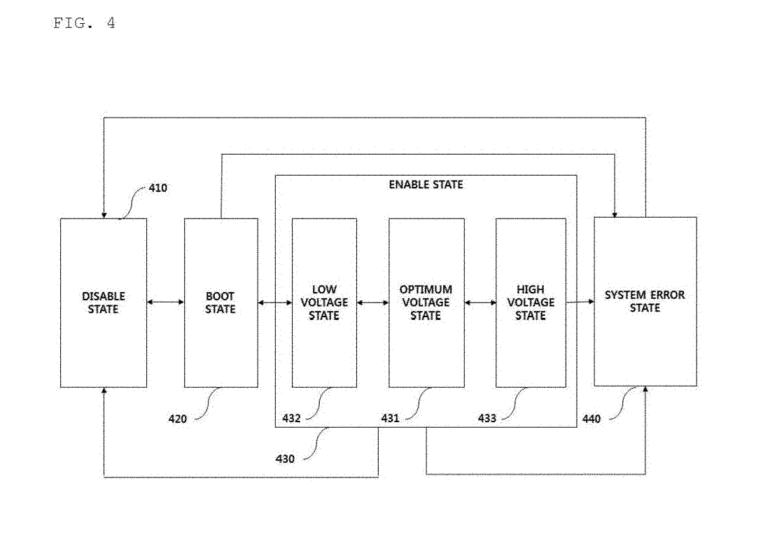

FIG. 4 is a state transition diagram of a wireless power receiver using an electromagnetic resonance mode according to an embodiment of the disclosure.

Referring to FIG. 4, a state of the wireless power receiver may largely include a disable state 410, a boot state 420, an enable state 430 (or an on state), and a system error state 440.

In this case, the state of the wireless power receiver may be determined based on intensity (hereinafter, for convenience of description, referred to as V_{RECT}) of an output voltage at an end of a rectifier of the wireless power receiver.

The enable state 430 may be divided into an optimum voltage state 431, a low voltage state 432, and a high voltage state 433 according to a value of V_{RECT}.

When a measured value of V_{RECT} is equal to or greater than a predetermined value of V_{RECT}_{_}_{BOOT}, the wireless power receiver in the disable state 410 may transition to the boot state 420.

In the boot state 420, the wireless power receiver may establish an out-of-band communication link with the wireless power transmitter and may stand by until a value of V_{RECT} reaches power required at an end of a load.

Upon checking that the value of V_{RECT} reaches power required at the end of the load, the wireless power receiver in the boot state 420 may transition to the enable state 430 and may begin charging.

Upon checking that charging is completed or stopped, the wireless power receiver in the enable state 430 may transition to the boot state 420.

Upon detecting predetermined system error, the wireless power receiver in the enable state 430 may transition to the system error state 440. Here, the system error may include other predefined system error conditions as well as over voltage, over current, and overheating.

When a value of V_{RECT} is reduced to a value of V_{RECT}_{_}_{BOOT} or less, the wireless power receiver in the enable state 430 may transition to the disable state 410.

In addition, when a value of V_{RECT} is reduced to a value of V_{RECT}_{_}_{BOOT} or less, the wireless power receiver in the boot state 420 or the system error state 440 may transition to the disable state 410.

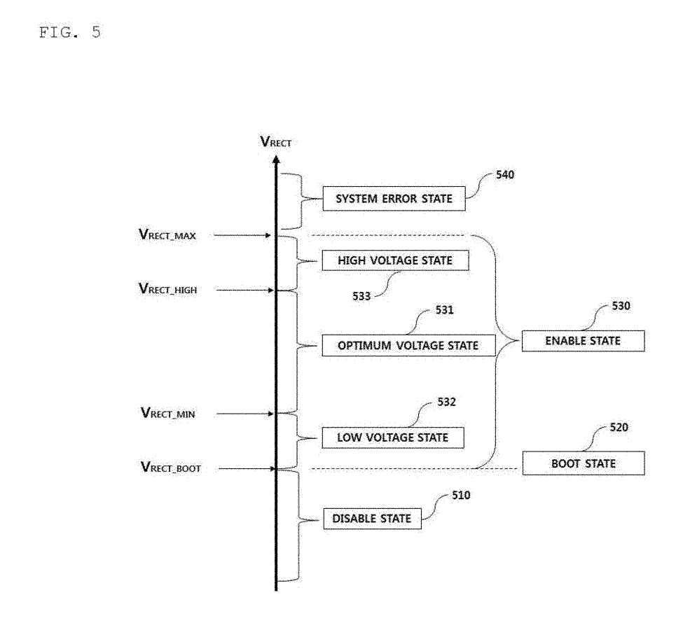

Hereinafter, state transition of the wireless power receiver in the enable state 430 will be described with reference to FIG. 5.

FIG. 5 is a diagram for explanation of an operating region of a wireless power receiver using an electromagnetic resonance mode depending on V_{RECT} according to an embodiment of the disclosure.

Referring to FIG. 5, when a value of V_{RECT} is less than a predetermined value of V_{RECT}_{_}_{BOOT}, the wireless power receiver may be maintained in the disable state 510.

Then, when a value of V_{RECT} is increased to V_{RECT}_{_}_{BOOT} or more, the wireless power receiver may transition to the boot state 520 and may broadcast an advertisement signal within a predetermined time. Then, upon detecting the advertisement signal, the wireless power transmitter may transmit a predetermined connection request signal for establishment of an out-of-band communication link to the wireless power receiver.

When the out-of-band communication link is normally established and registration is successful, the wireless power receiver may stand by until a value of V_{RECT} reaches a minimum output voltage (hereinafter, for convenience of description, referred to as V_{RECT}_{_}_{MIN}) at a rectifier for normal charging.

When a value of V_{RECT} exceeds V_{RECT}_{_}_{MIN}, the wireless power receiver may transition to the enable state 530 from the boot state 520 and begin charging of a load.

When a value of V_{RECT} exceeds a predetermined reference value V_{RECT}_{_}_{MAX} for determination of an over voltage in the enable state 530, the wireless power receiver may transition to the system error state 540 from the enable state 530.

Referring to FIG. 5, the enable state 530 may be divided into a low voltage state 532, an optimum voltage state 531, and a high voltage state 533 according to a value of V_{RECT}.

The low voltage state 532 may refer to a state of V_{RECT}_{_}_{BOOT}<=V_{RECT}<=V_{RECT}_{_}_{MIN}, the optimum voltage state 531 may refer to a state of V_{RECT}_{_}_{MIN}<V_{RECT}<=V_{RECT}_{_}_{HIGH} and the high voltage state 533 may refer to a state of V_{RECT}_{_}_{HIGH}<V_{RECT}<=V_{RECT}_{_}_{MAX}.

In particular, the wireless power receiver having transitioned to the high voltage state 533 may postpone an operation for shutting off power supplied to a load for predetermined time (hereinafter, for convenience of description, referred to as high voltage state holding time). In this case, the high voltage state holding time may be predetermined such that the wireless power receiver and the load are not adversely affected in the high voltage state 533.

When the wireless power receiver transitions to the system error state 540, the wireless power receiver may transmit a predetermined message indicating over voltage generation to the wireless power transmitter through an out-of-band communication link within predetermined time.

In addition, the wireless power receiver may control a voltage applied to a load using an over voltage interruption element that is installed for preventing a load from being damaged in the system error state 540. Here, the over voltage interruption element may be an ON/OFF switch and/or a Zener diode.

In the aforementioned embodiment, although a countermeasure method and element for system error in a wireless power receiver when an over voltage is generated in the wireless power receiver and the wireless power receiver transitions to the system error state 540 has been described this is merely an embodiment and, thus, according to another embodiment of the disclosure, the wireless power receiver may also transition to a system error state due to overheating, over current, etc. in the wireless power receiver.

For example, when the wireless power receiver transitions to a system error state due to overheating, the wireless power receiver may transmit a predetermined message indicating overheating generation to the wireless power transmitter. In this case, the wireless power receiver may drive an included cooling fan or the like so as to reduce internally generated heat.

According to another embodiment of the disclosure, the wireless power receiver may be operatively associated with a plurality of wireless power transmitters so as to wirelessly receive power. In this case, upon determining that a wireless power transmitter that is determined to actually wirelessly receive power is different from a wireless power transmitter with an out-of-band communication link that is actually established, the wireless power receiver may transition to the system error state 540.

Hereinafter, a signaling procedure between a wireless power transmitter and a wireless power receiver according to the disclosure will be described in detail with reference to the following diagrams.

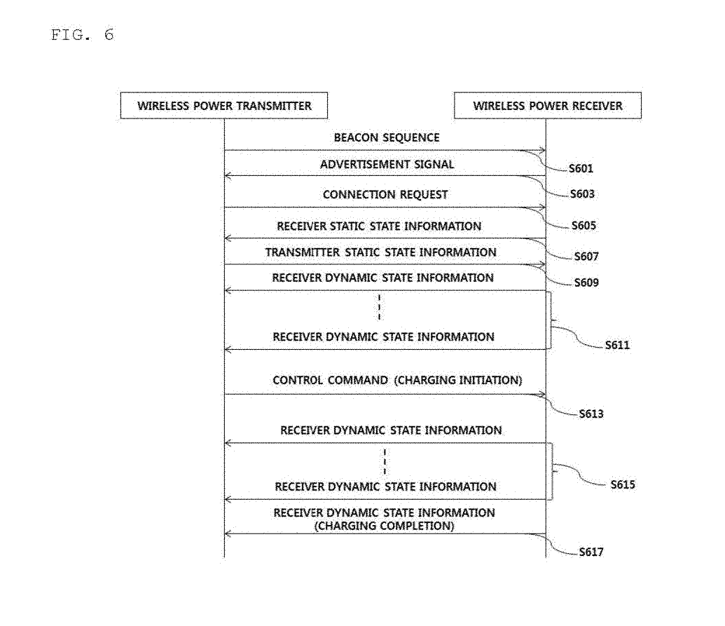

FIG. 6 is a flowchart for explanation of a wireless charging procedure using an electromagnetic resonance mode according to an embodiment of the disclosure.

Referring to FIG. 6, when configuration of the wireless power transmitter, i.e., booting is completed according to power supply, the wireless power transmitter may generate a beacon sequence and transmit the beacon sequence through a transmission resonator (S601).

Upon detecting the beacon sequence, the wireless power receiver may broadcast an advertisement signal containing identification information and characteristics information of the wireless power receiver (S603). In this case, it is noted that the advertisement signal may be repeatedly transmitted at a predetermined period until a connection request signal to be described later is received from the wireless power transmitter.

Upon receiving an advertisement signal, the wireless power transmitter may transmit a predetermined connection request signal for establishment of an out-of-band communication link to the wireless power receiver (S605).

Upon receiving the connection request signal, the wireless power receiver may establish the out-of-band communication link and transmit static state information of the wireless power receiver through the established out-of-band communication link (S607).

Here, the static state information of the wireless power receiver may include at least one of category information, hardware and software version information, maximum rectifier output power information, initial reference parameter information for power adjustment, information on required voltage or power, information for identifying whether a power adjustment function is installed, information on a supportable out-of-band communication mode, information on a supportable power control algorithm, and information on an initially set voltage value of an end of a preferred rectifier in a wireless power receiver.

Upon receiving the static state information of the wireless power receiver, the wireless power transmitter may transmit the static state information of the wireless power transmitter to the wireless power receiver through the out-of-band communication link (S609).

Here, the static state information of the wireless power transmitter may include at least one of transmitter power information, class information, hardware and software version information, information on a maximum number of supportable wireless power receivers, and/or a number of currently connected wireless power receivers.

Then, the wireless power receiver may monitor power reception state and charging state of the wireless power receiver in real time and may transmit dynamic state information to the wireless power transmitter periodically or when a specific event occurs (S611).

Here, the dynamic state information of the wireless power receiver may include at least one of information on output voltage and current of a rectifier, information on voltage and current applied to a load, information on an internally measured temperature of the wireless power receiver, reference parameter variation information (a minimum rectifying voltage value, a maximum rectifying voltage value, and initially set variation value in voltage at an end of a preferred rectifier) for power adjustment, charging state information, system error information, and alert information. The wireless power transmitter may change a setting value contained in existing static state information upon receiving the reference parameter variation information for power adjustment and perform power adjustment.

Upon preparing a sufficient amount of power for charging the wireless power receiver, the wireless power transmitter may transmit a predetermined control command through an out-of-band communication link and control the wireless power receiver to initiate charging (S613).

Then, the wireless power transmitter may receive dynamic state information from the wireless power receiver and may dynamically control transmitted power (S615).

When internal system error is detected or charging is completed, the wireless power receiver may add data for identifying corresponding system error and/or data indicating that charging is completed to the dynamic state information and transmit the information to the wireless power transmitter (S617). Here, the system error may include over current, over voltage, overheating, etc.

According to another embodiment of the disclosure, when currently available power does not satisfy required power of all wireless power receivers, the wireless power transmitter may redistribute power to be transmitted to each wireless power receiver and transmit the redistributed power to the corresponding wireless power receiver through a predetermined control command.

In addition, when a new wireless power receiver is additionally registered during wireless charging, the wireless power transmitter may redistribute power to be received for each connected wireless power receiver based on the currently available power and transmit the redistributed power to the corresponding wireless power receiver through a predetermined control command.

When an existing connected wireless power receiver is completely charged or an out-of-band communication link is released, e.g. the case in which the wireless power receiver is removed from a charging region, during wireless charging, the wireless power transmitter may redistribute power to be received for each maintained wireless power receiver and transmit the redistributed power to the corresponding wireless power receiver through a predetermined control command.

In addition, the wireless power transmitter may check whether the wireless power receiver has a power adjustment function installed therein through a predetermined control procedure. In this case, when a power redistribution situation occurs, the wireless power transmitter may redistribute power with respect to only a wireless power receiver having a power adjustment function installed therein.

For example, the power redistribution situation may occur when an event occurs, for example, when a valid advertisement signal is received from a non-connected wireless power receiver and a new wireless power receiver is added or a dynamic parameter indicating a current state of a connected wireless power receiver is received, when a pre-connected wireless power receiver is determined not to exist any longer, when a pre-connected wireless power receiver is completely charged, or when an alert message indicating a system error state of a pre-connected wireless power receiver is received.

Here, the system error state may include an over voltage state, an over current state, an overheating state, a network connection state, etc.

For example, the wireless power transmitter may transmit power redistribution related information to the wireless power receiver through a predetermined control command.

Here, the power redistribution related information may include command information for power adjustment of the wireless power receiver,

For example, when a new wireless power receiver is registered, the wireless power transmitter may determine whether a power amount required by the wireless power receiver is capable of being provided based on an available power amount of the wireless power transmitter. As the determination result, when the required power amount exceeds an available power amount, the wireless power transmitter may check whether a power adjustment function is installed in the corresponding wireless power receiver. As the checked result, when the power adjustment function is installed, the wireless power receiver may determine the amount of power to be received by the wireless power receiver within an available power amount and transmit the determination result to the wireless power receiver through a predetermined control command.

Needless to say, power redistribution may be performed within a range in which the wireless power transmitter and the wireless power receiver are capable of being normally operated and/or capable of being normally charged.

A wireless power receiver according to another embodiment of the disclosure may support a plurality of out-of-band communication modes. In order to change a currently established out-of-band communication link to a different manner, the wireless power receiver may transmit a predetermined control signal for requesting change in out-of-band communication to the wireless power transmitter. Upon receiving the request signal for change in out-of-band communication, the wireless power transmitter may release a currently established out-of-band communication link and establish a new out-of-band communication link using the out-of-band communication mode requested by the wireless power receiver.

For example, an out-of-band communication mode applicable to embodiments of the disclosure may include at least one of near field communication (NFC), radio frequency identification (RFID) communication, Bluetooth low energy (BLE) communication, wideband code division multiple access (WCDMA) communication, long term evolution (LTE)/LTE-advance communication, and Wi-Fi communication.

FIG. 7 is a state transition diagram for explanation of a wireless power transmission procedure of an electromagnetic induction mode according to an embodiment of the present disclosure.

Referring to FIG. 7, power transmission to a receiver from a transmitter according to the power matters alliance (PMA) standard may be roughly classified into a standby phase 710, a digital ping phase 720, an identification phase 730, a power transfer phase 740, and an end of charge phase 750.

The standby phase 710 may be a phase that is transitioned when a specific error or a specific event is detected while a receiver identification procedure for power transmission is performed or power transmission is maintained. Here, the specific error and the specific event would be obvious from the following description. In addition, in the standby phase 710, the transmitter may monitor whether an object is present on a charging surface.

When the transmitter detects that the object is present on the charging surface or is performing RXID reattempt, the standby phase 710 may be transitioned to the digital ping phase 720 (S701). Here, RXID refers to a unique identifier (ID) allocated to a PMA compatible receiver. In the standby phase 710, the transmitter may transmit an analog ping with a very short pulse and detect whether an object is present in an active area of an interface surface, e.g., a charging bed based on a current change of a transmission coil.

The transmitter transitioned to the digital ping phase 720 may emit a digital ping signal for identifying whether the detected object is a PMA compatible receiver. When sufficient power is supplied to a reception end according to the digital ping signal transmitted by the transmitter, the receiver may modulate the received digital ping signal according to a PMA communication protocol to transmit a predetermined response signal to a transmitter. Here, the response signal may include a signal strength indicator indicating intensity of power received by the receiver. In the digital ping phase 720, upon receiving an effective response signal, the receiver may be transitioned to the identification phase 730 (S702).

When, in the digital ping phase 720, the transmitter does not receive the response signal or the corresponding receiver is not a PMA compatible receiver, i.e., in the case of foreign object detection (FOD), the transmitter may be transitioned to the standby phase 710 (S703). For example, a foreign object (FO) may be a metallic object including a coin, a key, or the like.

In the identification phase 730, when the transmitter fails in a receiver identification procedure or needs to re-perform the receiver identification procedure and does not complete the receiver identification procedure within a predefined time period, the transmitter may be transitioned to the standby phase 710 (S704).

Upon succeeding in receiver identification, the transmitter may be transitioned to the power transfer phase 740 from the identification phase 730 and may initiate charging (S705).

In the power transfer phase 740, when the transmitter does not receive a desired signal within a predetermined time period (Time Out) or detects an FO, or a voltage of a reception coil exceeds a predefined reference value, the transmitter may be transitioned to the standby phase 710 (S706).

In the power transfer phase 740, when temperature detected by a temperature sensor included in the transmitter exceeds a predetermined reference value, the transmitter may be transitioned to the end of charge end 750 (S707).

In the end of charge end 750, upon checking that the receiver is removed from the charging surface, the transmitter [symbol] receiver may be transitioned to the standby phase 710 (S709).

In an over-temperature state, when measured temperature is lowered to a reference value or less after a predetermined time period elapses, the transmitter may be transitioned to the digital ping phase 720 from the end of charge end 750 (S710).

In the digital ping phase 720 or the power transfer phase 740, upon receiving an end of charge (EOC) request, the transmitter may be transitioned to the end of charge end 750 (S708 and S711).

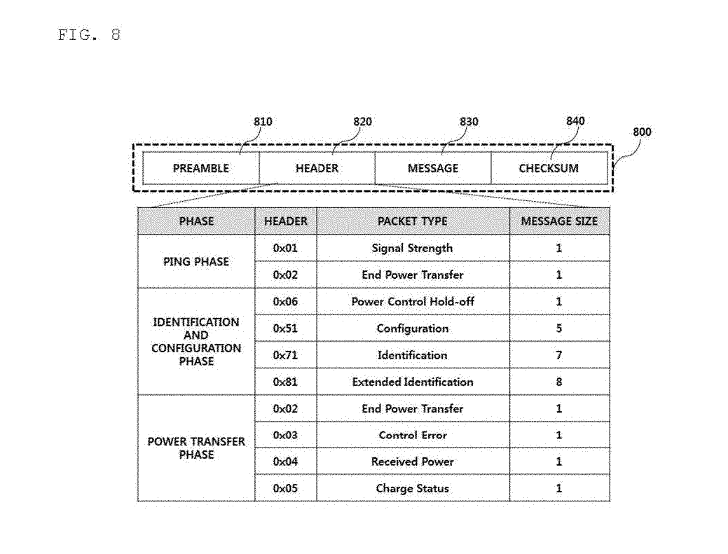

FIG. 8 is a diagram for explanation of a packet format depending on a wireless power transmission procedure of an electromagnetic induction mode according to an embodiment of the present disclosure.

Referring to FIG. 8, a packet format 800 used to exchange information between the wireless power transmitter and the wireless power receiver may include a preamble 810 field for synchronization acquisition for demodulation of a corresponding packet and identification of an accurate start bit of the corresponding packet, a header 820 field for identification of a type of a message included in the corresponding packet, a message 830 field for transmitting information (or a payload) of the corresponding packet, and a checksum 840 for field identifying whether error occurs in the corresponding packet.

As shown in FIG. 8, a packet reception end may identify a size of the message 830 included in the corresponding packet based on a value of the header 820.

The header 820 may define a wireless power transmission power for each phase and some values of the header 820 may be defined to be equal in different phases. For example, referring to FIG. 8, it may be noted that header values corresponding to end power transfer of the ping phase and end power transfer of the power transfer phase are the same value, 0x02.

The message 830 may include data to be transmitted by a transmission end of the corresponding packet. For example, the data included in the message 830 field may be report, request, or response of a counterpart but is not limited thereto.

According to another embodiment of the present disclosure, the packet 800 may further include at least one of transmission end identification information for identifying a transmission end for transmitting the corresponding packet and reception end identification information for identifying a reception end that is supposed to receive the corresponding packet. Here, the transmission end identification information and the reception end identification information may include, but are not limited to, IP address information, MAC address information, product identification information, and so on and may be any information as long as the information is capable of identifying the reception end and the transmission end in a wireless charging system.

According to another embodiment of the present disclosure, when the corresponding packet needs to be received by a plurality of devices, the packet 800 may further include predetermined group identification information for identifying a corresponding reception group.

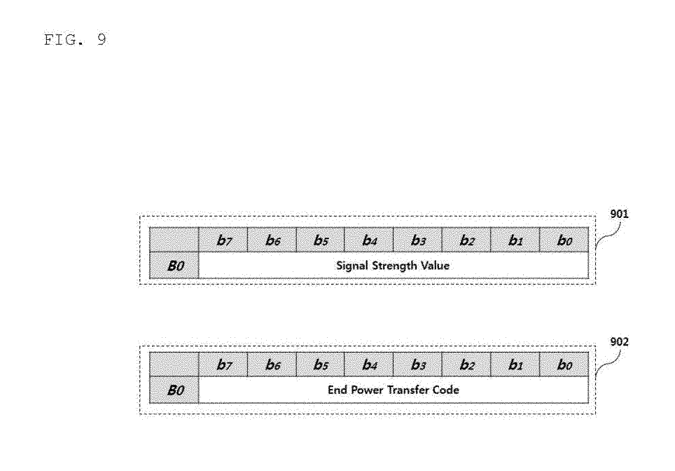

FIG. 9 is a diagram for explanation of a type of a packet that is to be transmitted in a ping phase by a wireless power reception apparatus depending on a wireless power transmission procedure of an electromagnetic induction mode according to an embodiment of the present disclosure.

As shown in FIG. 9, in the ping phase, the wireless power reception apparatus may transmit a signal strength packet or an end power transfer packet.

Referring to reference numeral 901 of FIG. 9, a message format of a signal strength packet according to an embodiment may include a signal strength value with a size of 1 byte. The signal strength value may indicate a degree of coupling between a transmission coil and a reception coil and may be a value calculated based on an output voltage of a rectifier in a digital ping period, an open circuit voltage measured by an output block switch or the like, intensity of received power, and so on. The signal strength value may have a range to a highest value of 255 from a lowest value of and, when an actually measured value U of a specific parameter is equal to a maximum value Umax of the corresponding parameter, the signal strength value may have a value of 255.

For example, the signal strength value may be calculated according to U/Umax*256.

Referring to reference numeral 902 of FIG. 9, a message format of the end power transfer packet according to an embodiment may be configured with an end power transfer code with a size of 1 byte.

The reason for making a request for the end power transfer by the wireless power reception apparatus may include charge complete, internal fault, over temperature, over voltage, over current, battery failure, reconfigure, no response, and so on but is not limited thereto. It may be noted that the end power transfer code is defined to correspond to each new reason for the end power transfer.

The charge complete may be used when a receiver battery is completed charged. The internal fault may be used when software or logical fault is detected in an internal operation of a receiver.

The over temperature/over voltage/over current may be used when a temperature/voltage/current value measured by a receiver exceeds each respective defined threshold value.

The battery failure may be used upon determining that failure occurs in a receiver battery.

The reconfigure may be used when a power transfer condition needs to be renegotiated. The no response may be used upon determining that a response of a transmitter with respect to a control error packet, i.e., increase or reduction in power intensity is not normal.

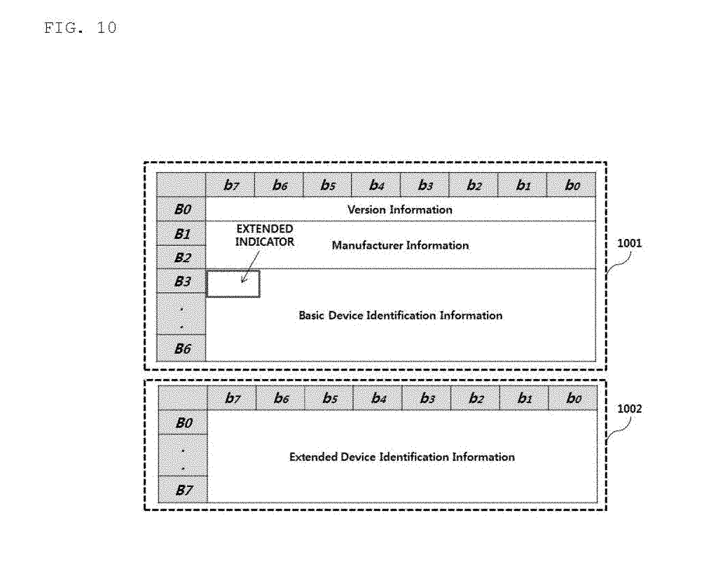

FIG. 10 is a diagram for explanation of a message format of an identification packet depending on a wireless power transmission procedure of an electromagnetic induction mode according to an embodiment of the present disclosure.

Referring to FIG. 10, the message format of the identification packet may include a version information field, a manufacturer information field, an extension indicator field, and a basic device identification information field.

The version information field may record revised version information of the standard applied to a corresponding wireless power reception apparatus.

The manufacturer information field may record a predetermined identification code for identifying a manufacturer that manufactures a corresponding wireless power reception apparatus.

The extension indicator field may be an indicator for identifying whether an extension identification packet including extension device identification information is present. For example, when an extension indicator value is 0, this may mean that the extension identification packet is not present and, when the extension indicator value is 1, this may mean that the extension identification packet is present after the identification packet.

Referring to reference numerals 1001 and 1002, when the extension indicator value is 0, a device identifier for a corresponding wireless power receiver may be configured via a combination of manufacturer information and basic device identification information. On the other hand, when the extension indicator value is 1, the device identifier for the corresponding wireless power receiver may be configured via a combination of manufacturer information, basic device identification information, and extension device identification information.

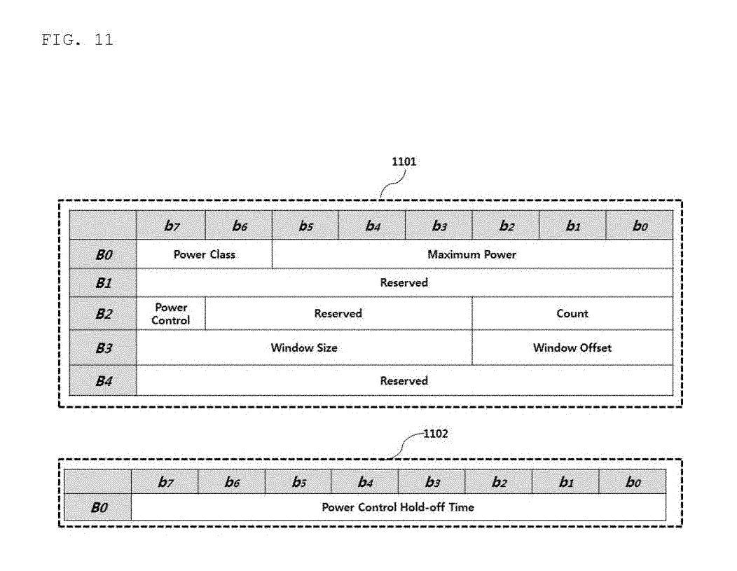

FIG. 11 is a diagram for explanation of a message format of a configuration packet and a power control hold-off packet depending on a wireless power transmission procedure of an electromagnetic induction mode according to an embodiment of the present disclosure.

Referring to reference numeral 1101 of FIG. 11, the message format of the configuration packet may have a length of 5 bytes and may be configured with a power class field, a maximum power field, a power control field, a count field, a window size field, a window offset field, and so on.

The power class field may record a power class allocated to a corresponding wireless power receiver.

The maximum power field may record an intensity value of maximum power to be provided by an output end of a rectifier of a wireless power receiver.

For example, when a power class is a and maximum power is b, maximum power energy Pₘₐₓ that is desired to be provided by an output end of a rectifier of a wireless power reception apparatus may be calculated according to (b/2)*10a.

The power control field may be used to indicate an algorithm that needs to be used for power control in a wireless power transmitter. For example, when a power control field value is 0, this may mean that a power control algorithm defined in the standard is applied and, when the power control field value is 1, this may mean that power control is performed according to an algorithm defined by a manufacturer.

The count field may be used to record the number of option configuration packets to be transmitted in identification and configuration phases by a wireless power reception apparatus.

The window size field may be used to record a window size for calculation of average reception power. For example, when a window size may be a positive integer value that is greater than 0 and has a unit of 4 ms.

The window offset field may record information for identifying a time period to a transfer start time of a next reception power packet from an average reception power calculation window end time. For example, the window offset may be a positive integer value that is greater than 0 and has a unit of 4 ms.

Referring to reference numeral 1102, a message format of the power control hold-off packet may include power control hold-off time T_delay. A plurality of power control hold-off packets may be transmitted in identification and configuration phases. For example, up to 7 power control hold-off packets may be transmitted. The power control hold-off time T_delay may have a value between a predefined minimum power control hold-off time T_min, 5 ms and a maximum power control hold-off time T_max, 205 ms. The wireless power transmission apparatus may perform power control using a power control hold-off time of a power control hold-off packet that is lastly received in identification and configuration phases. When the wireless power transmission apparatus does not receive a power control hold-off packet in identification and configuration phases, the T_min value may be used as the T_delay value.

The power control hold-off time may refer to a time when the wireless power transmission apparatus does not perform power control prior to actual power control after latest control error packet reception but, instead, needs to be on standby.

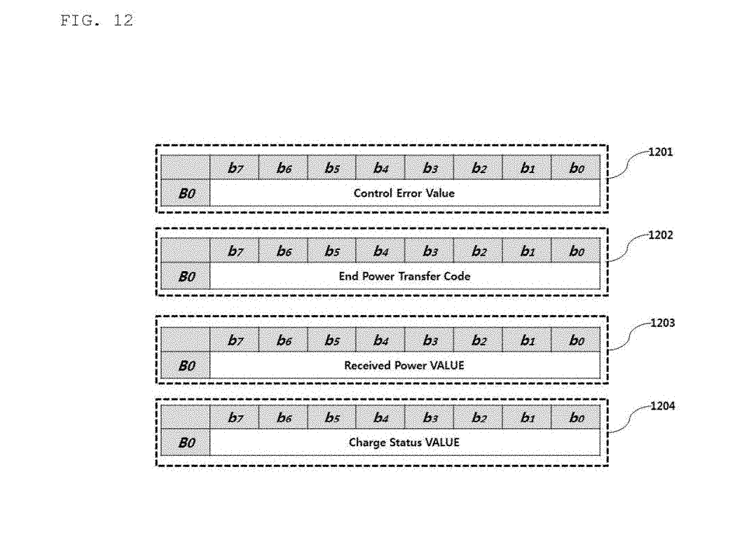

FIG. 12 is a diagram for explanation of a type of a packet that is to be transmitted in a power transfer phase by a wireless power reception apparatus and a message format of the packet depending on a wireless power transmission procedure of an electromagnetic induction mode according to an embodiment of the present disclosure.

Referring to FIG. 12, the packet that is to be transmitted by the wireless power reception apparatus in the power transfer phase may include a control error packet, an end power transfer packet, a received power packet, a charge status packet, a packet defined for each manufacturer, and so on.

Reference numeral 1201 indicates a message format of a control error packet configured with a control error value of 1 byte. Here, the control error value may be an integer value in the range of −128 to +127. When the control error value is negative, transmission power of a wireless power transmission apparatus may be lowered and, when the control error value is positive, the transmission power of the wireless power transmission apparatus may be increased.

Reference numeral 1202 indicates a message format of a control error packet configured with an end power transfer code of 1 byte.

Reference numeral 1203 indicates a message format of a received power packet configured with a received power value of 1 byte. Here, the received power value may correspond to an average rectifier received power value calculated during a predetermined period. Actually received power energy P_{received} may be calculated based on maximum power and power class included in the configuration packet 1101. For example, the actually received power energy may be calculated according to (received power value/128)*(maximum power/2)*(10^{power class}).

Reference numeral 1204 indicates a message format of a charge status packet configured with a charge status value of 1 byte. The charge status value may refer to a battery charge amount of a wireless power reception apparatus. For example, a charge status value 0 may refer to a completely discharged status, a charge status value 50 may refer to a 50% charge status, and a charge status value 100 may refer to a fully charged status. When the wireless power reception apparatus does not include a charge battery or does not provide charge status information, the charge status value may be set to OxFF.

Hereinafter, a multiplex-mode wireless power transmission mode for supporting both an electromagnetic resonance mode and an electromagnetic induction mode is described.

A multiplex-mode wireless power transmitter for supporting the electromagnetic induction mode and the electromagnetic resonance mode may also transmit power to a wireless power receiver that is operated in any one of the electromagnetic induction mode and the electromagnetic resonance mode and may also transmit power to a multiplex-mode wireless power receiver for supporting both the electromagnetic resonance mode and the electromagnetic induction mode. The multiplex-mode wireless power transmitter for supporting the electromagnetic induction mode and the electromagnetic resonance mode may be classified into a first type multiplex-mode wireless power transmitter for simultaneously supporting the above two modes and a second type multiplex-mode wireless power transmitter for supporting only any one of the above two modes.

The multiplex-mode wireless power receiver that supports both the electromagnetic induction mode and the electromagnetic resonance mode may wirelessly receive power from the wireless power transmitter that is operated in any one of the electromagnetic induction mode and the electromagnetic resonance mode as well as from the multiplex-mode wireless power transmitter that smoothly selects two wireless power transmission modes without user intervention and executes the selected mode. The multiplex-mode wireless power receiver that supports the electromagnetic induction mode and the electromagnetic resonance mode may be classified into a firs type multiplex-mode wireless power receiver for simultaneously supporting the above two modes and a second type multiplex-mode wireless power receiver for supporting only any one of the electromagnetic induction mode and the electromagnetic resonance mode.

The first type multiplex-mode wireless power transmitter according to an embodiment may simultaneously transmit power in the electromagnetic induction mode and the electromagnetic resonance mode and, to execute the two modes, the first type multiplex-mode wireless power transmitter may perform detection procedures corresponding to the respective modes. For example, the first type multiplex-mode wireless power transmitter may detect a multiplex-mode wireless power receiver or a wireless power receiver that is operated in any one of the electromagnetic induction mode and the electromagnetic resonance mode using an analog ping of the electromagnetic induction mode and a short beacon of the electromagnetic resonance mode. The first type multiplex-mode wireless power transmitter may perform detection procedures corresponding to the respective modes in a time sequence.

Upon detecting presence of the wireless power receiver that is operated in any one of the electromagnetic induction mode and the electromagnetic resonance mode, the first type multiplex-mode wireless power transmitter according to an embodiment may stop the detection procedure and may complete communication session establishment for performing wireless power transmission corresponding to the wireless power transmission mode that is previously detected.

Upon detecting presence of the multiplex-mode wireless power receiver that supports both the two above modes, the first type multiplex-mode wireless power transmitter according to an embodiment may continuously perform a detection procedure of another wireless power transmission mode other than the wireless power transmission mode that is previously detected.

When the first type multiplex-mode wireless power transmitter does not complete communication session establishment for wirelessly transmitting power to the multiplex-mode wireless power receiver or the wireless power receiver that is operated in any one of the electromagnetic induction mode and the electromagnetic resonance mode, the first type multiplex-mode wireless power transmitter may perform detection procedures corresponding to the respective modes in a time sequence.

While the first type multiplex-mode wireless power transmitter transmits power to any one wireless power transmission mode, if the second type multiplex-mode wireless power receiver attempts to establish a communication session for performing wireless power transmission using a different wireless power transmission mode from the existing wireless power transmission mode, the first type multiplex-mode wireless power transmitter may terminate wireless power transmission session establishment of the second type multiplex-mode wireless power receiver via a predefined process.

The first type multiplex-mode wireless power transmitter may receive a multiplex-mode advertisement signal for searching for a wireless power transmitter from the multiplex-mode wireless power receiver or a wireless power receiver that is operated in any one of the electromagnetic induction mode and the electromagnetic resonance mode.

The multiplex-mode advertisement signal may be used to search for a wireless power transmitter/receiver that is operated in an electromagnetic resonance mode and/or an electromagnetic induction mode.

The second type multiplex-mode wireless power transmitter may transmit power to only one to the electromagnetic induction mode and the electromagnetic resonance mode at one time and, to perform only any one of the two above modes, the second type multiplex-mode wireless power transmitter may apply a power signal to a coil to use a frequency of any one of the two above modes at one time.

When the second type multiplex-mode wireless power transmitter does not transmit power to the wireless power receiver, the second type multiplex-mode wireless power transmitter may perform detection procedures corresponding to the two modes. The detection procedures of the second type multiplex-mode wireless power transmitter do not require continuous operations of the two modes and, thus, the respective detection procedures of the modes may be performed to satisfy respective reference requirement timings.

The second type multiplex-mode wireless power transmitter may transmit power to a first multiplex-mode wireless power receiver that completes detection and authentication procedures that are required in any one of the two modes or the wireless power receiver that is operated in any one of the electromagnetic induction mode and the electromagnetic resonance mode.

While the second type multiplex-mode wireless power transmitter transmits power to any one wireless power transmission mode, the second type multiplex-mode wireless power transmitter may not attempt a detection procedure in another wireless power transmission mode.

The second type multiplex-mode wireless power transmitter may return to a detection procedure of a multiplex-mode mode when wireless power transmission is completed as defined in each of the two modes.

The second type multiplex-mode wireless power transmitter may also receive a multiplex-mode advertisement signal for searching for a wireless power transmitter from the multiplex-mode wireless power receiver or a wireless power receiver that is operated in any one of the electromagnetic induction mode and the electromagnetic resonance mode.

The second type multiplex-mode wireless power transmitter may include a user interface (UI) for displaying a status of a specific mode of an operation at a specific time point.

The first type multiplex-mode wireless power receiver may provide power required for a system when at least one mode of the electromagnetic induction mode and the electromagnetic resonance mode is activated.

The second type multiplex-mode wireless power receiver may support one mode at one time and the second type multiplex-mode wireless power receiver may not be damaged by the wireless power transmitter when the multiplex-mode power transmission mode is executed and may not damage the wireless power transmitter when the multiplex-mode power transmission mode is executed. However, when the multiplex-mode power transmission mode is executed, it may not be required to actively provide power to a load (system).

While receiving power, the multiplex-mode wireless power receiver may transmit whether power is received using one mode or two modes at one time.

When the multiplex-mode wireless power receiver is not currently capable of appropriately receiving power in any one of the two modes, the multiplex-mode wireless power receiver may perform automatic conversion to another mode. The multiplex-mode wireless power receiver may use a mechanism that is defined with respect to a specific mode to generate a signal for terminating any one wireless power transmission mode and may use a mechanism defined to set another mode.

In this case, the wireless power transmitter may determine a wireless power transmission mode to be adaptively used for a corresponding wireless power receiver based on a type, a status, requirement power, and so on of the wireless power receiver as well as a wireless power transmission mode that is supportable by the wireless power transmitter and the wireless power receiver.

The first type multiplex-mode wireless power receiver may perform switching in two modes using a method of preparing a next power reception mode prior to termination of an existing power reception mode to continuously perform power transmission by the first type multiplex-mode wireless power receiver. When switching fails, the first type multiplex-mode wireless power receiver may continuously receive power in a mode that has been performed prior to switching.

The first type multiplex-mode wireless power receiver may directly communicate with a new wireless power transmitter to reduce a time required for switching prior to termination of access to any one wireless power transmitter using a method of preparing a next power reception mode prior to termination of an existing power reception mode to reduce a time required for switching.

Prior to setting of another mode that is switched using a conversion method, a first type multiplex-mode wireless power receiver or a first type multiplex-mode wireless power transmitter that receives power from the second type multiplex-mode wireless power transmitter and a second type multiplex-mode wireless power receiver that receives power from the second type multiplex-mode wireless power transmitter needs to terminate a currently executed mode. However, when this attempt fails, the multiplex-mode wireless power receiver may attempt reconnection for executing a mode that has been originally executed.

The multiplex-mode wireless power receiver may perform communication using Bluetooth low energy (BLE) defined in the electromagnetic resonance mode only when a power carrier in a resonance frequency range is detected.

The multiplex-mode wireless power receiver may perform communication using in-band load modulation communication defined in an electromagnetic induction mode only when a power carrier in an induced frequency band defined in the electromagnetic induction mode is detected.

While the first type multiplex-mode wireless power transmitter transmits power in any one wireless power transmission mode, if the second type multiplex-mode wireless power receiver attempts to establish a communication session for performing wireless power transmission using a different wireless power transmission mode, the first type multiplex-mode wireless power transmitter may terminate wireless power transmission session establishment of the second type multiplex-mode wireless power receiver via a predefined process and, in this regard, when communication session connection for connection of the second type multiplex-mode wireless power receiver is unconditionally excluded, it may not be possible to simultaneously charge a wireless power receiver that previously transmits power and a newly detected second type multiplex-mode wireless power receiver.

Even if power transmission efficiency to the wireless power receiver that previously transmits power is higher than the newly detected second type multiplex-mode wireless power receiver, it may not be possible to charge the second type multiplex-mode wireless power receiver and, thus, overall charging may be inefficient. In addition, in a situation in which power needs to be urgently received due to the low remaining capacity of a battery of the newly detected second type multiplex-mode wireless power receiver, it may be required to preferentially transmit power to the newly detected second type multiplex-mode wireless power receiver.

The wireless power transmitter may transmit power to a plurality of wireless power receivers depending on an electromagnetic resonance mode and, during transmission of power to the plurality of wireless power receivers, the wireless power transmitter may transmit power in a power sharing mode of the wireless power transmitter.

The power sharing mode may be performed to power distribution/allocation between the plurality of wireless power receivers when the wireless power transmitter does not have output power for sufficiently transmitting power required by all of the plurality of wireless power receivers.

Statuses of a plurality of wireless power receivers may be determined based on intensity (hereinafter, PRU VRECT) of an output voltage at a rectifier end of the wireless power receiver and the wireless power transmitter may determine whether it is required to execute a power sharing mode depending on a VRECT status of each wireless power receiver.

When a new wireless power receiver to which a communication session for beginning power reception from the wireless power transmitter is connected completes registration, the wireless power transmitter may determine whether it is required to transmit lower power to transmit power to a new wireless power receiver than power that is currently received from the wireless power receiver prior to transmission of PRU Control characteristic for activating charging.

When the wireless power transmitter determines that power needs to be adjusted, a signal for allowing power transmission may be added to the PRU Control characteristic and may be transmitted to the new wireless power receiver.

Then, power adjustment may be performed on all wireless power receivers that are receiving power and “adjust power capability” information with 4 bits may be transmitted to the PRU Control characteristics for power adjustment.

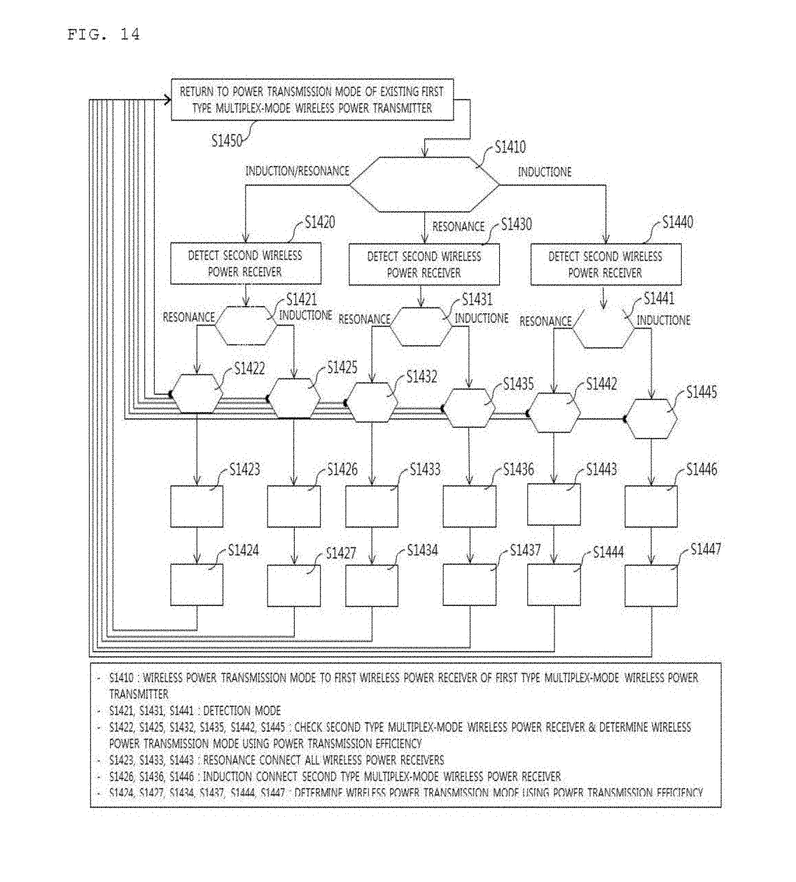

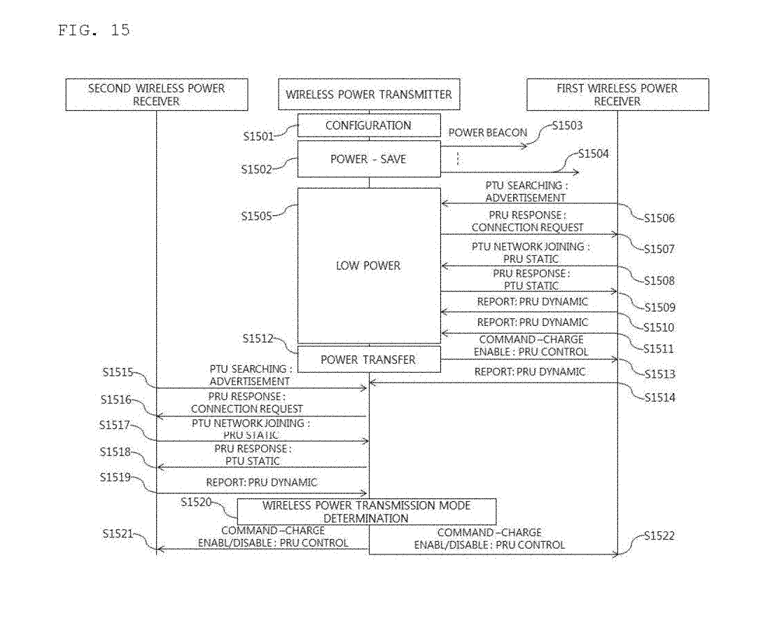

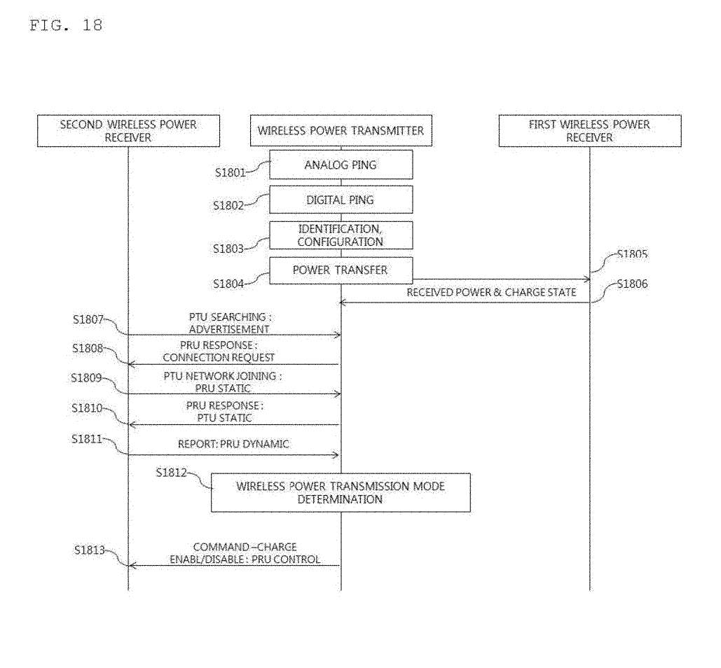

Hereinafter, schematic cases of a method of switching a power transmission mode by a multiplex-mode wireless power transmitter are described with reference to FIGS. 13 and 14, and a detailed procedure for performing switching in each case is described with reference to FIGS. 15 and 18.

FIG. 13 is a flowchart for explanation of a method of switching a power transmission mode by a multiplex-mode wireless power transmitter according to an embodiment of the present disclosure.

Referring to FIG. 13, the multiplex-mode wireless power transmitter may be a first type multiplex-mode wireless power transmitter that simultaneously transmits power using at least one of the electromagnetic induction mode and the electromagnetic resonance mode.

The method of switching a power transmission mode by the multiplex-mode wireless power transmitter may be largely classified into three operations.

The multiplex-mode wireless power transmitter may detect a second wireless power receiver while transmitting power to a first wireless power receiver (S1310).

The second wireless power receiver may be a second type multiplex-mode wireless power receiver that receives power using only any one of the electromagnetic resonance mode and the electromagnetic induction mode at one time. In this case, the multiplex-mode wireless power transmitter that is the first type multiplex-mode wireless power transmitter may not stop communication session connection for performing power transmission to the newly detected second type multiplex-mode wireless power receiver and may perform BLE communication or in-band communication for power transmission.

The multiplex-mode wireless power transmitter may calculate second power transmission efficiency with respect to the detected second wireless power receiver (S1320).

The multiplex-mode wireless power transmitter may calculate the second power transmission efficiency using status information of the second type multiplex-mode wireless power receiver, which is received via BLE communication or in-band communication. As a method of calculating power transmission efficiency, the multiplex-mode wireless power transmitter may calculate the power transmission efficiency using power applied to power transmission and output power calculated status information of the second type multiplex-mode wireless power receiver, but the method of calculating the power transmission efficiency is not limited thereto.

The multiplex-mode wireless power transmitter may compare first power transmission efficiency and second power transmission efficiency with respect to the first wireless power receiver to determine a final wireless power transmission mode (S1330).

The multiplex-mode wireless power transmitter may transmit power to at least one of the first wireless power receiver and the second wireless power receiver in at least one of the electromagnetic induction mode and the electromagnetic resonance mode according to the determined final wireless power transmission mode.

The multiplex-mode wireless power transmitter may determine the final wireless power transmission mode according to predetermined priority other than the power transmission efficiency.

According to an embodiment, the multiplex-mode wireless power transmitter may compare the first battery remaining amount of the first wireless power receiver and the second battery remaining amount of the second wireless power receiver to allocate high priority for power transmission to a wireless power receiver with a low battery remaining capacity.

According to another embodiment, the multiplex-mode wireless power transmitter may compare a first battery reduction variation amount of the first wireless power receiver and a second battery reduction variation amount of the second wireless power receiver to a high battery reduction variation amount.

While the first type multiplex-mode wireless power transmitter according to an embodiment transmits power in both the electromagnetic induction mode and the electromagnetic resonance mode, if the second type multiplex-mode wireless power receiver is detected in the electromagnetic resonance mode, connection and power transmission of the existing wireless power receiver that is being charged in the electromagnetic induction mode and both the existing wireless power receiver and the newly detected second type multiplex-mode wireless power receiver may be set to receive power in the electromagnetic resonance mode.

While the first type multiplex-mode wireless power transmitter according to an embodiment transmits power in the electromagnetic resonance mode, if the second type multiplex-mode wireless power receiver is detected in the electromagnetic resonance mode, the newly detected second type multiplex-mode wireless power receiver may perform negotiation and power transmission on a power transfer condition while power transmission of the existing wireless power receiver that is being charged in the electromagnetic resonance mode is maintained. Accordingly, both the existing wireless power receiver and the newly detected second type multiplex-mode wireless power receiver may be set to receive power in the electromagnetic resonance mode.

While the first type multiplex-mode wireless power transmitter according to an embodiment transmits power in the electromagnetic induction mode, if the second type multiplex-mode wireless power receiver is detected in the electromagnetic resonance mode, connection and power transmission of the existing wireless power receiver that is being charged in the electromagnetic induction mode are terminated and both the existing wireless power receiver and the newly detected second type multiplex-mode wireless power receiver may be set to receive power in the electromagnetic resonance mode.

Even if the second type multiplex-mode wireless power receiver is detected in the electromagnetic resonance mode, the first type multiplex-mode wireless power transmitter according to an embodiment may maintain existing power transmission when charging efficiency with respect to the second type multiplex-mode wireless power receiver is lower than charging efficiency with respect to the existing wireless power receiver that is being charged. The first type multiplex-mode wireless power transmitter according to an embodiment may return to a power transmission mode of pre-detection of the second type multiplex-mode wireless power receiver in consideration of the charging efficiency even after both the existing wireless power receiver and the newly detected second type multiplex-mode wireless power receiver are set to receive power in the electromagnetic resonance mode.

While the first type multiplex-mode wireless power transmitter according to an embodiment transmits power, if the second type multiplex-mode wireless power receiver is detected, connection of the second type multiplex-mode wireless power receiver may be terminated.

While the first type multiplex-mode wireless power transmitter according to an embodiment simultaneously transmits power in the electromagnetic induction mode and the electromagnetic resonance mode or transmits power in the electromagnetic induction mode or the electromagnetic resonance mode, if the second type multiplex-mode wireless power receiver is detected in the electromagnetic induction mode, the first type multiplex-mode wireless power transmitter may transmit power to the second type multiplex-mode wireless power receiver in the electromagnetic induction mode when charging efficiency with respect to the second type multiplex-mode wireless power receiver is higher than charging efficiency with respect to the existing wireless power receiver that is being charged.

The first type multiplex-mode wireless power transmitter according to an embodiment may return to a power transmission mode of pre-detection of the second type multiplex-mode wireless power receiver in consideration of the charging efficiency even after the first type multiplex-mode wireless power transmitter is set to transmit power to the second type multiplex-mode wireless power receiver in the electromagnetic induction mode.

While the first type multiplex-mode wireless power transmitter according to an embodiment simultaneously transmits power in the electromagnetic induction mode and the electromagnetic resonance mode, if the second type multiplex-mode wireless power receiver is detected in the electromagnetic induction mode, existing power transmission may be maintained when charging efficiency with respect to the second type multiplex-mode wireless power receiver is lower than charging efficiency with respect to the existing wireless power receiver that is being charged.

While the first type multiplex-mode wireless power transmitter according to an embodiment transmits power, if the second type multiplex-mode wireless power receiver is detected, connection of the second type multiplex-mode wireless power receiver may be terminated.

FIG. 14 is a flowchart for explanation of the number of cases depending on a wireless power transmission mode in a method of switching a power transmission mode by a wireless power transmitter of a multiplex-mode wireless power transmitter according to an embodiment of the present disclosure.

Referring to FIG. 14, the multiplex-mode wireless power transmitter may be a first type multiplex-mode wireless power transmitter that simultaneously transmits power in at least one mode of the electromagnetic induction mode and the electromagnetic resonance mode and the second wireless power receiver may be a second type multiplex-mode wireless power receiver that receives power in any one of the electromagnetic resonance mode and the electromagnetic induction mode at one time.

An operation of detecting the second wireless power receiver may be classified into S1420, S1430, and S1440 depending on a mode (an electromagnetic induction and resonance mode, an electromagnetic resonance mode, and an electromagnetic induction mode) in which the multiplex-mode wireless power transmitter transmits power to the first wireless power receiver.

Even if the multiplex-mode wireless power transmitter transmits power to the first wireless power receiver in the electromagnetic induction and resonance mode, when the second wireless power receiver is the second type multiplex-mode wireless power receiver, it may be possible to transmit power in any one of the electromagnetic resonance mode and the electromagnetic induction mode at one time and the second wireless power receiver may be detected using a detection mode based on any one of the electromagnetic resonance mode and the electromagnetic induction mode.

While the multiplex-mode wireless power transmitter according to an embodiment transmits power to the first wireless power receiver in the electromagnetic resonance and induction mode, the second wireless power receiver may be detected using a detection mode based on any one of the electromagnetic resonance mode and the electromagnetic induction mode.

While the multiplex-mode wireless power transmitter transmits power to the first wireless power receiver in the electromagnetic resonance and induction mode, the second wireless power receiver may be detected in the electromagnetic resonance mode (S1421).

The multiplex-mode wireless power transmitter according to an embodiment may check whether the wireless power receiver that is detected according to a BLE-based advertisement (AD) signal or the like in a configuration state is the second type multiplex-mode wireless power receiver.

The multiplex-mode wireless power transmitter may check that the second wireless power transmitter is the second type multiplex-mode wireless power receiver and may calculate power transmission efficiency in each situation before and after switching to determine whether a power transmission mode is switched (S1422).

According to an embodiment, when the second wireless power receiver is detected in a detection mode based on the electromagnetic resonance mode (S1422), the multiplex-mode wireless power transmitter may calculate power transmission efficiency (PTE1=(PR1+PR2)/(PT1+PT2)) during transmission of power to only one wireless power receiver as a pre-switching situation using transmission power PT1 in the electromagnetic resonance mode and the transmission power PT2 in the electromagnetic induction mode to the first wireless power receiver, and reception power PR1 in the electromagnetic resonance mode and the reception power PR2 of the first wireless power receiver in electromagnetic induction mode.

The multiplex-mode wireless power transmitter may calculate power transmission efficiency (PTE2=(PRa1+PRb1)/(PT1)) during simultaneous transmission of power to two wireless power receivers as a post-switching situation using reception power PRa1 of the first wireless power receiver in an electromagnetic resonance mode according to the electromagnetic resonance mode and reception power PRb1 of the second wireless power receiver in the electromagnetic resonance mode. The multiplex-mode wireless power transmitter may compare PTE1 and PTE2 to determine whether power is transmitted to the first and second wireless power transmitters or power is transmitted only to the existing first wireless power receiver (S1422).

When PTE2 is greater than PTE1, the multiplex-mode wireless power transmitter may connect a communication session in an electromagnetic resonance mode with respect to the second wireless power receiver and may transmit power to the second wireless power receiver while maintaining power transmission in the electromagnetic resonance mode with respect to the first wireless power receiver to simultaneously transmit power to the first wireless power receiver and the second wireless power receiver in the electromagnetic resonance mode (S1423).

Then, the multiplex-mode wireless power transmitter may receive state information including reception power from the first and second wireless power receivers at a predetermined period to calculate power transmission efficiency and may re-determine whether power is transmitted to at least one of the first and second wireless power receivers with the power transmission efficiency in any one of the electromagnetic induction mode and the electromagnetic resonance mode (S1424).

Needless to say, the multiplex-mode wireless power transmitter may determine a final wireless power transmission mode according to preset priority other than the power transmission efficiency.

According to an embodiment, the multiplex-mode wireless power transmitter may compare the first battery remaining amount of the first wireless power receiver and the second battery remaining amount of the second wireless power receiver to allocate high priority with respect to power transmission to a wireless power receiver with the low remaining capacity of a battery and, according to another embodiment, the multiplex-mode wireless power transmitter may compare the first battery reduction variation amount of the first wireless power receiver and the second battery reduction variation amount of the second wireless power receiver to allocate high priority with power transmissions to a wireless power receiver with a high battery reduction variation amount.

While transmitting power to the first wireless power receiver in the electromagnetic resonance and induction mode, the multiplex-mode wireless power transmitter may detect the second wireless power receiver in the electromagnetic induction mode (S1421).

The multiplex-mode wireless power transmitter may check whether the second wireless power transmitter is a second type multiplex-mode wireless power receiver and may calculate power transmission efficiency in each situation before and after switching to determine whether a power transmission mode is switched (S1425).

Similarly to S1422, the multiplex-mode wireless power transmitter may calculate power transmission efficiency (PTE1=(PR1+PR2)/(PT1+PT2)) during transmission of power to only one wireless power receiver using the transmission power PT1 in the electromagnetic resonance mode and the transmission power PT2 in the electromagnetic induction mode to the first wireless power receiver, and the reception power PR1 in the electromagnetic resonance mode and the reception power PR2 in the electromagnetic induction mode of the first wireless power receiver.

The multiplex-mode wireless power transmitter may calculate power transmission efficiency (PTE3=(PRc1)/(PT2)) with respect to only the second wireless power receiver using reception power PRc1 in the electromagnetic induction mode with respect to only the second wireless power receiver and may compare PTE1 and PTE3 to determine whether power is transmitted to the first and second wireless power transmitters or power is transmitted only to the second wireless power receiver in the electromagnetic induction mode (S1425).

When PTE3 is greater than PTE1, the multiplex-mode wireless power transmitter may stop power transmission of the electromagnetic resonance mode with respect to the first wireless power receiver, may connect a communication session in the electromagnetic induction mode only to the second wireless power receiver, and may transmit power to the second wireless power receiver in the electromagnetic induction mode, to transmit power only to the second wireless power receiver in the electromagnetic induction mode (S1426).

Similarly, then, the multiplex-mode wireless power transmitter may receive state information including reception power from the second wireless power receiver at a predetermined period, may calculate power transmission efficiency, and may re-determine a power transmission mode with respect to a wireless power receiver to which power is to be transmitted (S1427).

The multiplex-mode wireless power transmitter may transmit power only to the existing first wireless power receiver according to re-determination (S1450).

Even if each second wireless power receiver is detected in the electromagnetic resonance mode or the electromagnetic induction mode, the multiplex-mode wireless power transmitter may calculate similar power transmission efficiency to the above case and may determine a power transmission mode with high efficiency and a target wireless power receiver of power transmission.

Needless to say, the multiplex-mode wireless power transmitter may determine a final wireless power transmission mode according to preset priority other than the power transmission efficiency.

According to an embodiment, the multiplex-mode wireless power transmitter may compare the first battery remaining amount of the first wireless power receiver and the second battery remaining amount of the second wireless power receiver to allocate high priority with respect to power transmission to a wireless power receiver with the low remaining capacity of a battery and, according to another embodiment, the multiplex-mode wireless power transmitter may compare the first battery reduction variation amount of the first wireless power receiver and the second battery reduction variation amount of the second wireless power receiver to allocate high priority with power transmissions to a wireless power receiver with a high battery reduction variation amount.

While transmitting power to the first wireless power receiver in the electromagnetic resonance mode, the multiplex-mode wireless power transmitter may detect the second wireless power receiver in the electromagnetic resonance mode (S1431).

The multiplex-mode wireless power transmitter according to an embodiment may check whether the wireless power receiver is detected according to a BLE-based advertisement (AD) signal or the like in a configuration state is the second type multiplex-mode wireless power receiver.

The multiplex-mode wireless power transmitter may check that the second wireless power transmitter is the second type multiplex-mode wireless power receiver and may calculate power transmission efficiency in each situation before and after switching to determine whether a power transmission mode is switched (S1432).

According to an embodiment, when the second wireless power receiver is detected in a detection mode based on the electromagnetic resonance mode (S1432), the multiplex-mode wireless power transmitter may calculate power transmission efficiency (PTE4=PR1/PT1) with respect to the first wireless power receiver as a pre-switching situation using the transmission power PT1 to the first wireless power receiver in the electromagnetic resonance mode and the reception power PR1 of the first wireless power receiver in the electromagnetic resonance mode.

The multiplex-mode wireless power transmitter may calculate power transmission efficiency (PTE5=(PRa1+PRb1)/(PT1)) during simultaneous transmission of power to two wireless power receivers as a post-switching situation using reception power PRa1 of the first wireless power receiver in an electromagnetic resonance mode according to the electromagnetic resonance mode and reception power PRb2 of the second wireless power receiver in the electromagnetic resonance mode. The multiplex-mode wireless power transmitter may compare PTE4 and PTE5 to determine whether power is transmitted only to the first wireless power receiver or power is simultaneously transmitted to the first and second wireless power receivers (S1432).

When PTE5 is greater than PTE4, the multiplex-mode wireless power transmitter may connect a communication session in an electromagnetic resonance mode with respect to the second wireless power receiver and may transmit power to the second wireless power receiver while maintaining power transmission in the electromagnetic resonance mode with respect to the first wireless power receiver to simultaneously transmit power to the first wireless power receiver and the second wireless power receiver in the electromagnetic resonance mode (S1433).

Then, the multiplex-mode wireless power transmitter may receive state information including reception power from the first and second wireless power receivers at a predetermined period to calculate power transmission efficiency and may re-determine whether power is transmitted to at least one of the first and second wireless power receivers with the power transmission efficiency in the electromagnetic resonance mode (S1434).

Needless to say, the multiplex-mode wireless power transmitter may determine a final wireless power transmission mode according to preset priority other than the power transmission efficiency.

While transmitting power to the first wireless power receiver in the electromagnetic resonance mode, the multiplex-mode wireless power transmitter may detect the second wireless power receiver in the electromagnetic induction mode (S1431).

The multiplex-mode wireless power transmitter according to an embodiment may transmit a detection signal (e.g., a ping signal) based on the electromagnetic induction mode at a predetermined period to detect the second wireless power receiver.

The multiplex-mode wireless power transmitter may check that the second wireless power transmitter is the second type multiplex-mode wireless power receiver and may calculate power transmission efficiency in each situation before and after switching to determine whether a power transmission mode is switched (S1435).

According to an embodiment, when the second wireless power receiver is detected in a detection mode based on the electromagnetic induction mode (S1435), the multiplex-mode wireless power transmitter may calculate power transmission efficiency (PTE4=PR1/PT1) with respect to the first wireless power receiver as a pre-switching situation using the transmission power PT1 to the first wireless power receiver in the electromagnetic resonance mode and the reception power PR1 of the first wireless power receiver in the electromagnetic resonance mode.

The multiplex-mode wireless power transmitter may calculate power transmission efficiency (PTE6=(PR2)/(PT2)) with respect to the second wireless power receiver as a post-switching situation using transmission power PT2 to the second wireless power receiver in the electromagnetic induction mode and reception power PR2 of the second wireless power receiver in the electromagnetic induction mode. The multiplex-mode wireless power transmitter may compare PTE4 and PTE6 to determine whether power is transmitted only to the first wireless power receiver or power is transmitted only to the second wireless power receiver (S1435).

When PTE6 is greater than PTE4, the multiplex-mode wireless power transmitter may stop power transmission of the electromagnetic resonance mode with respect to the first wireless power receiver, may connect a communication session in the electromagnetic induction mode to the second wireless power receiver, and may transmit power to the second wireless power receiver, to transmit power to the second wireless power receiver in the electromagnetic induction mode (S1436).

Then, the multiplex-mode wireless power transmitter may receive state information including reception power from the first and second wireless power receivers at a predetermined period to calculate power transmission efficiency and may re-determine whether power is transmitted to at least one of the first and second wireless power receivers with the power transmission efficiency in the electromagnetic resonance mode (S1437).

Needless to say, the multiplex-mode wireless power transmitter may determine a final wireless power transmission mode according to preset priority other than the power transmission efficiency.

While transmitting power to the first wireless power receiver in the electromagnetic induction mode, the multiplex-mode wireless power transmitter may detect the second wireless power receiver in the electromagnetic resonance mode (S1441).

The multiplex-mode wireless power transmitter according to an embodiment may check whether the wireless power receiver is detected according to a BLE-based advertisement (AD) signal or the like in a configuration state is the second type multiplex-mode wireless power receiver.

The multiplex-mode wireless power transmitter may check that the second wireless power transmitter is the second type multiplex-mode wireless power receiver and may calculate power transmission efficiency in each situation before and after switching to determine whether a power transmission mode is switched (S1442).

According to an embodiment, when the second wireless power receiver is detected in a detection mode based on the electromagnetic resonance mode (S1442), the multiplex-mode wireless power transmitter may calculate power transmission efficiency (PTE7=PR2/PT2) with respect to the first wireless power receiver as a pre-switching situation using the transmission power PT2 to the first wireless power receiver in the electromagnetic induction mode and the reception power PR2 of the first wireless power receiver in the electromagnetic induction mode.

The multiplex-mode wireless power transmitter may calculate power transmission efficiency (PTE8=(PRa1+PRb1)/(PT1)) during simultaneous transmission of power to two wireless power receivers as a post-switching situation using transmission power PT1 to the first and second wireless power receivers in the electromagnetic resonance mode, reception power PRa1 of the first wireless power receiver in the electromagnetic resonance mode, and reception power PRb2 of the second wireless power receiver in the electromagnetic resonance mode. The multiplex-mode wireless power transmitter may compare PTE7 and PTE8 to determine whether power is transmitted only to the first wireless power receiver or power is simultaneously transmitted to the first and second wireless power receivers (S1442).

When PTE8 is greater than PTE7, the multiplex-mode wireless power transmitter may stop power transmission of the electromagnetic induction mode with respect to the first wireless power receiver, may connect a communication session in an electromagnetic resonance mode with respect to the first and second wireless power receivers, and may transmit power to the first and second wireless power receivers, to simultaneously transmit power to the first wireless power receiver and the second wireless power receiver in the electromagnetic resonance mode (S1443).

Then, the multiplex-mode wireless power transmitter may receive state information including reception power from the first and second wireless power receivers at a predetermined period to calculate power transmission efficiency and may re-determine whether power is transmitted to at least one of the first and second wireless power receivers with the power transmission efficiency in the electromagnetic resonance mode (S1444).

Needless to say, the multiplex-mode wireless power transmitter may determine a final wireless power transmission mode according to preset priority other than the power transmission efficiency.

While transmitting power to the first wireless power receiver in the electromagnetic induction mode, the multiplex-mode wireless power transmitter may detect the second wireless power receiver in the electromagnetic induction mode (S1441).

The second wireless power receiver according to an embodiment may transmit a signal of requesting for power transmission to the multiplex-mode wireless power transmitter using power to the first wireless power receiver and the multiplex-mode wireless power transmitter may detect the second wireless power receiver according to the signal.

The multiplex-mode wireless power transmitter may check that the second wireless power transmitter is the second type multiplex-mode wireless power receiver and may calculate power transmission efficiency in each situation before and after switching to determine whether a power transmission mode is switched (S1445).

According to an embodiment, when the second wireless power receiver is detected in a detection mode based on the electromagnetic induction mode (S1445), the multiplex-mode wireless power transmitter may calculate power transmission efficiency (PTE7=PR2/PT2) with respect to the first wireless power receiver as a pre-switching situation using the transmission power PT2 to the first wireless power receiver in the electromagnetic induction mode and the reception power PR2 of the first wireless power receiver in the electromagnetic induction mode.

The multiplex-mode wireless power transmitter may calculate power transmission efficiency (PTE9 (PRb2)/(PTb2)) to the second wireless power receiver as a post-switching situation using transmission power PTb2 in the electromagnetic induction mode to the second wireless power receiver and reception power PRb2 of the second wireless power receiver in the electromagnetic induction mode. The multiplex-mode wireless power transmitter may compare PTE7 and PTE9 and may determine whether power is transmitted only to the first wireless power receiver or power is transmitted only to the second wireless power receiver (S1445).

When PTE9 is greater than PTE7, the multiplex-mode wireless power transmitter may stop power transmission of the electromagnetic induction mode with respect to the first wireless power receiver, may connect a communication session in the electromagnetic induction mode with respect to the second wireless power receiver, and may transmit power to the second wireless power receiver, to transmit power to the second wireless power receiver in the electromagnetic induction mode (S1446).

Then, the multiplex-mode wireless power transmitter may receive state information including reception power from the first and second wireless power receivers at a predetermined period to calculate power transmission efficiency and may re-determine whether power is transmitted to at least one of the first and second wireless power receivers with the power transmission efficiency in the electromagnetic resonance mode (S1447).

Needless to say, the multiplex-mode wireless power transmitter may determine a final wireless power transmission mode according to preset priority other than the power transmission efficiency.

FIG. 15 is a flowchart for explanation of a method of switching a power transmission mode by a multiplex-mode wireless power transmitter when a wireless power receiver in an electromagnetic resonance mode is detected during power transmission in an electromagnetic resonance mode according to an embodiment of the present disclosure. Referring to FIG. 15, according to an embodiment of the present disclosure, the corresponding case is a case in which the multiplex-mode wireless power transmitter detects the second wireless power receiver in the electromagnetic resonance mode while transmitting power to the first wireless power receiver in the electromagnetic resonance mode and uses the wireless charging procedure in the electromagnetic resonance mode described with reference to FIG. 6.

When power is supplied to the multiplex-mode wireless power transmitter, the multiplex-mode wireless power transmitter may enter an environment configuration state (S1501).

Then, the multiplex-mode wireless power transmitter may enter a power save state in the environment configuration state (S1502).

The multiplex-mode wireless power transmitter may apply heterogeneous detection power beacons at respective periods in the power save state. For example, the multiplex-mode wireless power transmitter may apply a detection power beacon (e.g., a short beacon or a long beacon) (S1503 and S1504) and, in this case, power values of the detection power beacons may be different.

Some or all of the detection power beacons may have power energy for driving a communicator of the first wireless power receiver or the second wireless power receiver. For example, the first wireless power receiver or the second wireless power receiver may drive the communicator using some or all of the detection power beacons to communicate with the multiplex-mode wireless power transmitter. In this case, a state of the first wireless power receiver or the second wireless power receiver may be referred to as a null state or a disable state.

Hereinafter, the case in which the multiplex-mode wireless power transmitter first receives power from the first wireless power receiver in the electromagnetic resonance mode and, then, the second wireless power receiver is detected. The second wireless power receiver may drive the communicator using power for transmitting power to the first wireless power receiver by the multiplex-mode wireless power transmitter.

The multiplex-mode wireless power transmitter may detect a load change based on arrangement of the first wireless power receiver and may enter a low power state after detecting the load change (S1505).

The first wireless power receiver may drive the communicator based on power received from the multiplex-mode wireless power transmitter to transmit a wireless power transmitter searching (PTU searching: advertisement) signal to the multiplex-mode wireless power transmitter (S1506).

The first wireless power receiver may transmit a BLE-based advertisement (AD) signal as a signal for searching for a multiplex-mode wireless power transmitter. The first wireless power receiver may periodically transmit the PTU searching signal and may receive a response signal from the multiplex-mode wireless power transmitter or may transmit the PTU searching signal until a preset time is reached.

The first wireless power receiver may detect identification information of a multiplex-mode wireless power transmitter, included in the beacon signal transmitted from the multiplex-mode wireless power transmitter, may add the detected identification information to the advertisement signal, and may transmit the advertisement signal.

Upon receiving the PTU searching signal from the first wireless power receiver, the multiplex-mode wireless power transmitter may transmit a PRU response signal (S1507). Here, the PRU response signal may form connection between the multiplex-mode wireless power transmitter and the first wireless power receiver.

After connection between the multiplex-mode wireless power transmitter and the first wireless power receiver is formed, the first wireless power receiver may transmit a PRU static signal (S1508). Here, the PRU static signal may indicate a state of the first wireless power receiver and may be used to make a request for subscription to a wireless power network controlled by the multiplex-mode wireless power transmitter.

The multiplex-mode wireless power transmitter may transmit the PTU static signal (S1509). The PTU static signal transmitted by the multiplex-mode wireless power transmitter may indicate capability of the multiplex-mode wireless power transmitter.

When the multiplex-mode wireless power transmitter and the first wireless power receiver transmit and receive the PRU static signal and the PTU static signal, the first wireless power receiver may periodically transmit a PRU dynamic signal (S1510 and S1511).

The PRU dynamic signal may include at least one parameter information item measured by the first wireless power receiver. For example, the PRU dynamic signal may include voltage information of a rear end of a rectifier of a wireless power receiver 750. In this case, the state of the first wireless power receiver may be referred to as a boot state.

The multiplex-mode wireless power transmitter may enter a power transfer state (S1512) and the multiplex-mode wireless power transmitter may transmit a PRU control signal that is a command signal for ordering the first wireless power receiver to perform charging (S1513). In the power transfer state, the multiplex-mode wireless power transmitter may transmit charging power.

The PRU control signal transmitted by the multiplex-mode wireless power transmitter may include information for enabling/disabling charging of the first wireless power receiver and permission information. The PRU control signal may be transmitted whenever a charging state is changed. The PRU control signal may be transmitted, e.g., every 250 ms or may be transmitted whenever a parameter is changed. The PRU control signal may be set to be transmitted within a preset threshold time, e.g., one second even if the parameter is not changed.

The first wireless power receiver may change setting according to the PRU control signal and may transmit a wireless power receiver dynamic (PRU dynamic) signal for reporting the state of the first wireless power receiver (S1514).

The PRU dynamic signal transmitted from the first wireless power receiver may include at least one of voltage, current, and state and temperature information of the first wireless power receiver. The state of the first wireless power receiver may be referred to as an On-state. The PRU dynamic signal may have a data structure shown in Table 2 below.

TABLE 2

| Field | Octets | Description | Use | Units |
|---|---|---|---|---|
| Optional fields | 1 | Defines which optional fields are | Mandatory | |
| validity | | populated | | |
| V_{RECT} | 2 | DC voltage at the output of the rectifier. | Mandatory | mV |
| I_{RECT} | 2 | DC voltage at the output of the rectifier. | Mandatory | mA |
| V_{OUT} | 2 | Voltage at charge/battery port | Optional | mV |
| I_{OUT} | 2 | Current at charge/battery port | Optional | mA |
| T_{Ratio} | 1 | Current temperature of PRU relative to | Optional | Bit field |
| | | its OTP temperature | | |
| V_{RECT}_MIN_DYN | 2 | The current dynamic minimum rectifier | Optional | mV |
| | | voltage desired | | |
| V_{RECT}_SET_DYN | 2 | Desired V_{RECT} (dynamic value) | Optional | mV |
| V_{RECT}_HIGH_DYN | 2 | The current dynamic maximum rectifier | Optional | mv |
| | | voltage desired | | |
| PRU alert | 1 | Warnings | Mandatory | Bit field |
| Tester Command | 1 | PTU Test Mode Command | Optional | Bit Field |
| RFU | 2 | Undefined | | |

Referring to Table 2 above, the PRU dynamic signal may include at least one field. Each field may set selective field information, voltage information at an output of a rectifier of the first wireless power receiver, current information of the rectifier of the first wireless power receiver, voltage information of an output of a DC/DC converter of the first wireless power receiver, current information of an output of the DC/DC of the first wireless power receiver, temperature information, minimum voltage information (V_{RECT}_{_}_{MIN}_{_}_{DYN}) of an output of the rectifier of the first wireless power receiver, optimum voltage information (V_{RECT}_{_}_{SET}_{_}_{DYN}) of the output of the rectifier of the first wireless power receiver, maximum voltage information (V_{RECT}_{_}_{HIGH}_{_}_{DYN}) of the output of the rectifier of the first wireless power receiver, warning information (PRU alert), and so on. The PRU dynamic signal may include at least one of the above fields.

For example, at least one of voltage setting values (e.g., minimum voltage information (V_{RECT}_{_}_{MIN}_{_}_{DYN}) of the output of the rectifier of the first wireless power receiver, optimum voltage information (V_{RECT}_{_}_{SET}_{_}_{DYN}) of the output of the rectifier of the first wireless power receiver, and maximum voltage information (V_{RECT}_{_}_{HIGH}_{_}_{DYN}) of the output of the rectifier of the wireless power receiver) determined depending on a charging situation may be added to a corresponding field of the PRU dynamic signal and may be transmitted. As such, the multiplex-mode wireless power transmitter that receives the PRU dynamic signal may adjust wireless charging voltage to be transmitted to each first wireless power receiver with respect to the voltage setting values included in the PRU dynamic signal.

Thereamong, the warning information (PRU alert) may form a data structure shown in Table 3 below.

TABLE 3

| 7 | 6 | 5 | 4 | 3 | 2 | 1 | 0 |
|---|---|---|---|---|---|---|---|
| Over- | Over- | Over- | PRU | Charge | Wired | PRU | Adjust |
| voltage | current | temp | Self- | Com- | Charger | Charge | Power |
| | | | protec- | plete | Detect | Port | Re- |
| | | | tion | | | | sponse |

Referring to Table 3 above, the warning information may include over voltage, over current, over temperature, first wireless power receiver self protection (PRU self protection), charge complete, wired charger detect, a PRU charge port of a wireless power receiver 75, and adjust power response.

When ‘1’ is set to the over voltage field, this may indicate that voltage V_{rect} at the first wireless power receiver exceeds a limit over voltage. The over current and the over temperature may be set in the same way as the over voltage. The first wireless power receiver self protection (PRU Self Protection) may indicate that the first wireless power receiver may directly protect itself by reducing power applied to a load and, in this case, it may not be necessary to change a charging state of the multiplex-mode wireless power transmitter. The PRU charge port of the wireless power receiver 75 may be set to “1” to indicate that port output for wireless power transmission of the wireless power receiver 75. The adjust power response may be used to indicate whether the first wireless power receiver adjusts output power P_{RECT} thereof in response to a power adjust command. For example, when the first wireless power receiver adjusts output power according to the power adjust command of the multiplex-mode wireless power transmitter, an adjust power response bit may be set to “1” and the first wireless power receiver may receive the power adjust command and may adjust the output power P_{RECT} within several seconds (e.g., 1 second).

During power transfer to the first wireless power receiver, the multiplex-mode wireless power transmitter may receive a wireless power transmitter searching (PTU searching: advertisement) signal from the second wireless power receiver. The second wireless power receiver may drive a communicator using power for transmitting power to the first wireless power receiver by the multiplex-mode wireless power transmitter.

In this case, the multiplex-mode wireless power transmitter may not stop a communication session for wireless power transmission with the second wireless power receiver and may transmit a PRU response signal (S1516). Here, the PRU response signal may form connection between the multiplex-mode wireless power transmitter and the second wireless power receiver.

After connection between the multiplex-mode wireless power transmitter and the second wireless power receiver is formed, the first wireless power receiver may transmit the PRU static signal (S1517) and the multiplex-mode wireless power transmitter may transmit the PTU static signal (S1518).

When the multiplex-mode wireless power transmitter and the second wireless power receiver transmit and receive the PRU static signal and the PTU static signal, the second wireless power receiver may periodically transmit the PRU dynamic signal (S1519).

The multiplex-mode wireless power transmitter may calculate first power transmission efficiency and second power transmission efficiency based on the dynamic signal of the first wireless power receiver and the dynamic signal of the second wireless power receiver, respectively.

The multiplex-mode wireless power transmitter may compare the first and second power transmission efficiencies to determine a target wireless power receiver of power transmission from the first and second wireless power receivers and a final wireless power transmission mode (S1520).

The multiplex-mode wireless power transmitter may determine a target wireless power receiver of power transmission and a wireless power transmission mode in consideration of the remaining capacity of a battery of the first and second wireless power receivers and a variation amount of the battery as well as the power transmission efficiency.

According to an embodiment, priority of separately considered information such as the remaining amount of a battery and the variation amount of the battery and power transmission efficiency may be separately configured.

For example, even if power transmission efficiency of the first wireless power receiver is high, when the remaining amount of a battery of the second wireless power receiver is lower than a threshold value, the multiplex-mode wireless power transmitter may preferentially transmit power only to the second wireless power receiver.

The multiplex-mode wireless power transmitter may add enable/disable information on power transmission to the PRU control signal based on the calculated first power transmission efficiency and second power transmission efficiency and may transmit a PRU control signal to the first and second wireless power receivers to determine a final wireless power transmission mode (S1521 and S1522).

The multiplex-mode wireless power transmitter may calculate first reception power and second reception power using the rectifier output voltage V_{rect} and the rectifier output current I_{rect} from the first wireless power receiver and the second wireless power receiver, respectively. Then, the multiplex-mode wireless power transmitter may calculate whole power efficiency of input power of the multiplex-mode wireless power transmitter itself and the first and second reception power.

According to an embodiment, the multiplex-mode wireless power transmitter may assume power PT1 input to transmit power to the first wireless power receiver in the electromagnetic resonance mode, power PT2 input to transmit power in the electromagnetic induction mode, reception power PRa1 of the first wireless power receiver in the electromagnetic resonance mode, power PRa2 received in the electromagnetic induction mode, power PRb1 received by the second wireless power receiver in the electromagnetic resonance mode, and power PRb2 received in the electromagnetic induction mode.

As pre-switching power transmission efficiency, power transmission efficiency when the multiplex-mode wireless power transmitter transmits power to the first wireless power receiver only in the electromagnetic resonance mode may be PTE1=(PRa1)/PT1, and power transmission efficiency when power is transmitted to both the first wireless power receiver and the second wireless power receiver in the electromagnetic resonance mode may be PTE2=(PRa1+PRb2)/(PT1). Post-switching power transmission efficiency when the multiplex-mode wireless power transmitter transmits power to the second wireless power receiver only in the electromagnetic resonance mode may be PTE3=(PRb1)/(PT1). The multiplex-mode wireless power transmitter may compare PTE1, PTE2, and PTE3 to determine a target wireless power receiver of power transmission and a wireless power transmission mode.

The multiplex-mode wireless power transmitter may transmit a PRU control signal to the first and second wireless power receivers to enable or disable power transmission, to transmit power according to the determination (S1522).

For example, when power transmission efficiency to the first wireless power receiver is lower than power transmission efficiency to the first and second wireless power receivers or power transmission efficiency to the second wireless power receiver, the multiplex-mode wireless power transmitter may transmit the PRU control signal to the first wireless power receiver to disable power transmission. Needless to say, power transmission is simply stopped and the multiplex-mode wireless power transmitter may be capable of performing BLE communication with the first wireless power receiver.

Then, during re-determination of the power transmission efficiency, the multiplex-mode wireless power transmitter may retransmit a control signal (charge enable) for transmitting power only to the first wireless power receiver.

Even if the multiplex-mode wireless power transmitter transmits the control signal for disabling power transmission to the first or second wireless power receiver to stop power transmission, the multiplex-mode wireless power transmitter may be capable of performing BLE communication with the first or second wireless power receiver and, then, may transmit power to another wireless power receiver according to re-determination.

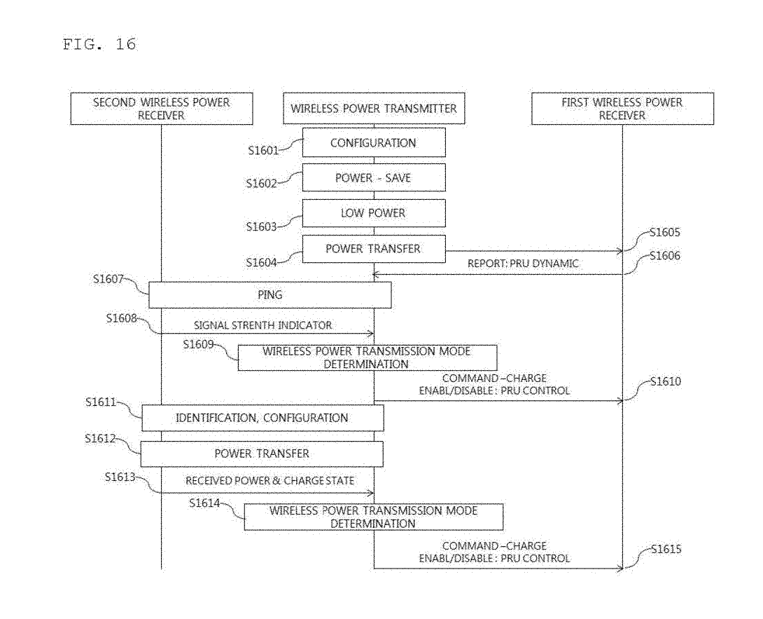

FIG. 16 is a flowchart for explanation of a method of switching a power transmission mode by a multiplex-mode wireless power transmitter when a wireless power receiver in an electromagnetic induction mode is retrieved during power transmission based on an electromagnetic resonance mode according to an embodiment of the present disclosure.

Referring to FIG. 16, an embodiment of the present disclosure corresponds to a case in which the multiplex-mode wireless power transmitter according to an embodiment of the present disclosure detects a second wireless power receiver in an electromagnetic induction mode during power transmission to the first wireless power receiver in the electromagnetic resonance mode.

A procedure of transmitting power to the first wireless power receiver from the multiplex-mode wireless power transmitter in the electromagnetic resonance mode and a procedure of receiving dynamic state information from the first wireless power receiver (S1601 to S1606) are the same as FIG. 16 and is different from FIG. 16 in terms of a procedure of detecting the second wireless power receiver in the electromagnetic induction mode by the multiplex-mode wireless power transmitter.

When detecting existence of the wireless power receiver that is capable of supporting both the electromagnetic induction mode and the electromagnetic resonance mode, the multiplex-mode wireless power transmitter may continuously perform a detection procedure of another wireless power transmission mode other than a first detected wireless power transmission mode.

The electromagnetic resonance mode and the electromagnetic induction mode may have respective different operating frequencies, and the multiplex-mode wireless power transmitter may also perform a detection procedure based on the electromagnetic induction mode during power transmission to the first wireless power receiver in the electromagnetic resonance mode.

The multiplex-mode wireless power transmitter may perform a detection procedure based on each mode to execute the electromagnetic induction mode and the electromagnetic resonance mode and may transmit analog ping of the electromagnetic induction mode to the wireless power receiver between beacons for detection (S1607).

The multiplex-mode wireless power transmitter may transmit analog ping with a very short pulse and may detect whether an object is present in an active area of an interface surface, e.g., a charging bed, based on a current change of a transmission coil.

The multiplex-mode wireless power transmitter may transmit a digital ping signal for identifying whether the detected object is a PMA compatible receiver (S1607). When sufficient power is supplied to the wireless power receiver according to the digital ping signal transmitted from the multiplex-mode wireless power transmitter, the receiver may modulate the received digital ping signal according to a PMA communication protocol and may transmit a predetermined response signal to a transmitter (S1608). Here, the response signal may include a signal strength indicator indicating intensity of power received by the receiver. In a digital ping phase, upon receiving an effective response signal, the receiver may be transitioned in to an identifying operation (S1610).

A signal strength value of the signal strength indicator may indicate a degree of coupling between a transmission coil and a reception coil and may be calculated based on a rectifier output voltage in the digital ping phase, an open circuit voltage measured by an output block switch or the like, intensity of reception power, and so on.

The multiplex-mode wireless power transmitter may calculate power efficiency with respect to the second wireless power receiver using power information applied to a coil to transmit a digital ping signal and rectifier output current included in the received signal strength indicator.

According to another embodiment of calculation of power efficiency with respect to the second wireless power receiver, the multiplex-mode wireless power transmitter may set different operating frequencies for first and second wireless power receivers, respectively.

The multiplex-mode wireless power transmitter may calculate power transmission efficiency using intensity of a magnetic field formed from the first and second wireless power receivers using the different operating frequencies, respectively. In detail, the multiplex-mode wireless power transmitter may calculate power transmission efficiency using a degree of coupling between transmission and reception coils using a change in the magnetic field, which is fed back from the magnetic field formed at the different operating frequencies.

The multiplex-mode wireless power transmitter may compare the second power transmission efficiency calculated using the signal strength indicator and the first power transmission efficiency calculated using state information included in the dynamic state information (PRU dynamic) received from the first wireless power receiver. The multiplex-mode wireless power transmitter may compare the first and second power transmission efficiencies to determine a target wireless power receiver of power transmission (S1609).

According to an embodiment, the wireless power receiver may repeatedly receive state information at a predetermined period and the multiplex-mode wireless power transmitter may determine a wireless power transmission mode and a target wireless power receiver of power transmission whenever the state information is received from the wireless power receiver.

The multiplex-mode wireless power transmitter may transmit a control signal (PRU control) for disabling power transmission to the first wireless power receiver to stop power transmission to the first wireless power receiver when efficiency of the second wireless power receiver in the electromagnetic induction mode is high.

Then, the multiplex-mode wireless power transmitter may perform authentication and configuration operations (S1611 and S1612) and the multiplex-mode wireless power transmitter may receive reception power received during power transmission to the second wireless power receiver and information on the remaining capacity of a battery of the second wireless power receiver (S1613).

In this case, the multiplex-mode wireless power transmitter may determine whether power is continuously transmitted to the second wireless power receiver or power is re-transmitted to the existing first wireless power receiver, based on the reception power and information on the remaining capacity of the battery of the second wireless power receiver.

For example, when power transmission efficiency based on an electromagnetic induction mode to the second wireless power transmitter is lower than a threshold value, the multiplex-mode wireless power transmitter may re-determine a wireless power transmission mode and a target wireless power receiver of power transmission (S1614) and may re-transmit a control signal for enabling power transmission to the first wireless power receiver (S1615).

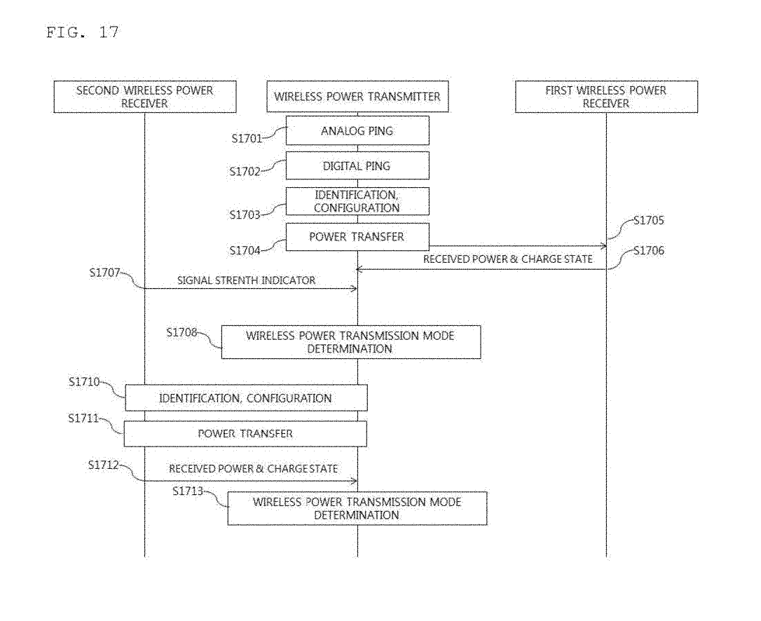

FIG. 17 is a flowchart for explanation of a method of switching a power transmission mode by a multiplex-mode wireless power transmitter when a wireless power receiver in an electromagnetic induction mode is retrieved during power transmission in an electromagnetic induction mode according to an embodiment of the present disclosure.

Referring to FIG. 17, an embodiment of the present disclosure corresponds to a case in which the multiplex-mode wireless power transmitter detects a second wireless power receiver in an electromagnetic induction mode during power transmission to the first wireless power receiver in the electromagnetic induction mode.

A procedure of transmitting power to the first wireless power receiver from the multiplex-mode wireless power transmitter in the electromagnetic induction mode and a procedure of connecting a communication session for executing the electromagnetic induction mode with the second wireless power receiver are also the same as in FIG. 17.

However, the communicator of the second wireless power receiver may be driven using power transmitted to the first wireless power receiver and the second wireless power receiver may transmit a signal strength indicator of some of power transmitted to the first wireless power receiver to the multiplex-mode wireless power transmitter (S1707).

The multiplex-mode wireless power transmitter may calculate the first power transmission efficiency using reception power from the first wireless power receiver and battery state information of the first wireless power receiver. The multiplex-mode wireless power transmitter may calculate the second power transmission efficiency using state information of the second wireless power receiver, included in the signal strength indicator (S1707) that is received from the next-detected second wireless power receiver in the digital ping phase.

The multiplex-mode wireless power transmitter may compare the first power transmission efficiency and the second power transmission efficiency to determine a power transmission mode and a target wireless power receiver of power transmission (S1708).

Similarly to FIG. 16, the multiplex-mode wireless power transmitter may transmit an end power transfer signal to stop power transmission to the first wireless power transmitter when power transmission efficiency to the second wireless power transmitter is high.

In this case, the multiplex-mode wireless power transmitter may use information (e.g., RXID) for identifying the first wireless power transmitter to stop power transmission to the first wireless power transmitter.

According to an embodiment, the multiplex-mode wireless power transmitter may lower power for the first wireless power receiver or may stop power transmission to the first wireless power receiver to transition the first wireless power receiver into the digital ping phase, may store the first wireless power receiver in a black list and, then, may disregard a signal from the first wireless power receiver.

Then, the multiplex-mode wireless power transmitter may re-determine a power transmission mode and a target wireless power receiver of power transmission in consideration of information on the remaining capacity of the battery during power transmission to the second wireless power receiver (S1712).

For example, when the remaining capacity of the battery of the second wireless power receiver is greater than a threshold value, the multiplex-mode wireless power transmitter may stop power transmission to the second wireless power receiver and may begin to transmit power to the first wireless power receiver. In this case, the multiplex-mode wireless power transmitter may transmit the end power transfer signal to the second wireless power receiver.

According to an embodiment, the multiplex-mode wireless power transmitter may release the first wireless power receiver registered in the black list, may receive a signal from the first wireless power receiver in the digital ping phase, and may connect a communication session for power transmission.

FIG. 18 is a flowchart for explanation of a method of switching a power transmission mode by a multiplex-mode wireless power transmitter when a wireless power receiver in an electromagnetic resonance mode is received during power transmission in an electromagnetic induction mode according to an embodiment of the present disclosure.

Referring to FIG. 18, an embodiment of the present disclosure may correspond to a case in which the multiplex-mode wireless power transmitter detects the second wireless power receiver in the electromagnetic resonance mode during power transmission to the first wireless power receiver in the electromagnetic induction mode.

A procedure of transmitting power to the first wireless power receiver from the multiplex-mode wireless power transmitter in the electromagnetic induction mode is the same as in FIG. 18 and a procedure of connecting a communication session for executing the electromagnetic resonance mode with the second wireless power receiver are also the same as in FIG. 18.

The multiplex-mode wireless power transmitter may also detect the second wireless power receiver using a detection signal (e.g., a beacon signal) based on the electromagnetic induction mode even in the power transfer phase based on electromagnetic induction mode to the first wireless power receiver.

The second wireless power receiver may transmit the advertisement signal to the multiplex-mode wireless power transmitter in response to the detection signal (S1807). A subsequent BLE communication process based on the electromagnetic induction mode is the same as in FIG. 15.

The multiplex-mode wireless power transmitter may calculate the first power transmission efficiency using reception power from the first wireless power receiver and battery state information of the first wireless power receiver.

The multiplex-mode wireless power transmitter may calculate the second power transmission efficiency using voltage information of an output of a rectifier, current information of the output of the rectifier of the second wireless power receiver, voltage information of an output of a DC/DC converter of the second wireless power receiver, and current information of the output of the DC/DC converter of the second wireless power receiver, which are included in the dynamic state information (S1811) received from the second wireless power receiver.

The multiplex-mode wireless power transmitter may compare the first power transmission efficiency and the second power transmission efficiency to determine a power transmission mode and a target wireless power receiver of power transmission.

In this case, the multiplex-mode wireless power transmitter may reduce or stop power transmission with respect to the first wireless power receiver and may transition the first wireless power receiver into the digital ping phase, to stop power transmission from the first wireless power receiver. The multiplex-mode wireless power transmitter may register identification information on the first wireless power receiver transitioned to the digital ping phase in the black list and may disregard a signal from the first wireless power receiver.

The multiplex-mode wireless power transmitter may re-determine a power transmission mode and a target wireless power receiver of power transmission in consideration of information on the remaining capacity of a battery during power transmission to the second wireless power receiver.

When power efficiency with respect to the first wireless power transmitter is high, the multiplex-mode wireless power transmitter may release identification information of the first wireless power transmitter registered in the black list, may be transitioned into authentication and configuration operations, and may retransmit power.

The method according to the aforementioned embodiment may be prepared in a program to be executable in a computer and may be stored in a computer readable recording medium. Examples of the computer readable recording medium include read-only memory (ROM), random-access memory (RAM), CD-ROMs, magnetic tapes, floppy disks, optical data storage devices, etc. and may be realized in the form of a carrier wave (for example, transmission over the Internet).

The computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

Those skilled in the art will appreciate that the present disclosure may be carried out in other specific ways than those set forth herein without departing from the spirit and essential characteristics of the present disclosure.

It will be apparent to those skilled in the art that various modifications and variations can be made in the present disclosure without departing from the spirit or scope of the present disclosure. Thus, it is intended that the present disclosure cover the modifications and variations of the embodiment provided they come within the scope of the appended claims and their equivalents.

### INDUSTRIAL APPLICABILITY

A wireless power transmission mode switching method according to an embodiment may be used in a wireless power transmitter and receiver for transmitting and receiving power in any one of an electromagnetic resonance mode and an electromagnetic induction mode at one time in consideration of power transmission efficiency.

### SEQUENCE LIST TEXT

100: wireless power transmitter

110: power supply

120: power converter

130: matching circuit

140: transmission resonator

150: main controller

160: communicator

200: wireless power receiver

210: reception resonator

220: rectifier

230: DC-DC converter

240: load

250: main controller

260: communicator

201: matching circuit

202: transmission resonator coil

203: reception resonator coil

204: matching circuit

211: L1

212: L2

1. A method of switching a wireless power transmission mode by a multiplex-mode wireless power transmitter, the method comprising:
detecting a second wireless power receiver during power transmission to a first wireless power receiver;
calculating second power transmission efficiency with respect to the detected second wireless power receiver; and
comparing first power transmission efficiency with respect to the first wireless power receiver and the second power transmission efficiency to determine a wireless power transmission mode,
wherein the multiplex-mode wireless power transmitter simultaneously transmits power in at least one mode of an electromagnetic induction mode and an electromagnetic resonance mode; and
wherein the second wireless power receiver receives power in only any one of the electromagnetic resonance mode and the electromagnetic induction mode at one time.

2. The method according to claim 1, wherein the comparing of the first power transmission efficiency with respect to the first wireless power receiver and the second power transmission efficiency to determine the wireless power transmission mode comprises determining the wireless power transmission mode based on a comparison result of the first power transmission efficiency and the second power transmission efficiency and preset priority.

3. The method according to claim 2, wherein the priority is increased as a remaining capacity of a battery of each of the first and second wireless power receivers is lowered.

4. The method according to claim 2, wherein the priority is increased as a battery reduction variation amount of each of the first and second wireless power receivers is increased.

5. The method according to claim 1, wherein the comparing of the first power transmission efficiency with respect to the first wireless power receiver and the second power transmission efficiency to determine the wireless power transmission mode comprises transmitting power to at least one of the first wireless power receiver and the second wireless power receiver in at least one of the electromagnetic induction mode and the electromagnetic resonance mode.

6. The method according to claim 5, wherein the transmitting of power to at least one of the first wireless power receiver and the second wireless power receiver in at least one of the electromagnetic induction mode and the electromagnetic resonance mode comprises:
terminating power transmission in the electromagnetic induction mode to the first wireless power receiver; and
transmitting power to the first wireless power receiver and the second wireless power receiver in the electromagnetic resonance mode.

7. The method according to claim 5, wherein the transmitting of power to at least one of the first wireless power receiver and the second wireless power receiver in at least one of the electromagnetic induction mode and the electromagnetic resonance mode comprises transmitting power to the second wireless power receiver in the electromagnetic resonance mode while maintaining power transmission in the electromagnetic resonance mode to the first wireless power receiver.

8. The method according to claim 5, wherein the transmitting of power to at least one of the first wireless power receiver and the second wireless power receiver in at least one of the electromagnetic induction mode and the electromagnetic resonance mode comprises:
terminating power transmission to the first wireless power receiver; and
transmitting power to the second wireless power receiver in the electromagnetic induction mode.

9. The method according to claim 5, wherein the transmitting of power to at least one of the first wireless power receiver and the second wireless power receiver in at least one of the electromagnetic induction mode and the electromagnetic resonance mode comprises maintaining power transmission with respect to the first wireless power receiver and terminating a communication session for power transmission in the electromagnetic induction mode with respect to the second wireless power receiver.

10. The method according to claim 1, further comprising calculating the first power transmission efficiency with respect to the first wireless power receiver while transmitting power to the first wireless power receiver.

11. A multiplex-mode wireless power transmitter for simultaneously transmitting power in at least one mode of an electromagnetic induction mode and an electromagnetic resonance mode, the multiplex-mode wireless power transmitter comprising:
a detector for detecting a second wireless power receiver during power transmission to a first wireless power receiver, and
a controller for calculating second power transmission efficiency with respect to the detected second wireless power receiver and comparing first power transmission efficiency with respect to the first wireless power receiver and the second power transmission efficiency to determine a final wireless power transmission mode,
wherein the second wireless power receiver receives power in only any one of an electromagnetic resonance mode and an electromagnetic induction mode at one time.

12. The multiplex-mode wireless power transmitter according to claim 11, the controller determines the final wireless power transmission mode based on a comparison result of the first power transmission efficiency with respect to the first wireless power receiver and the second power transmission efficiency and preset priority.

13. The multiplex-mode wireless power transmitter according to claim 12, the priority is increased as a remaining capacity of a battery of each of the first and second wireless power receivers is lowered.

14. The multiplex-mode wireless power transmitter according to claim 12, the priority is increased as a battery reduction variation amount of each of the first and second wireless power receivers is increased.

15. The multiplex-mode wireless power transmitter according to claim 11, the controller transmits power to at least one of the first wireless power receiver and the second wireless power receiver in at least one of the electromagnetic induction mode and the electromagnetic resonance mode.

16. The multiplex-mode wireless power transmitter according to claim 15, the controller terminates power transmission in the electromagnetic induction mode to the first wireless power receiver and may transmit power to the first wireless power receiver and the second wireless power receiver in the electromagnetic resonance mode.

17. The multiplex-mode wireless power transmitter according to claim 15, the controller transmits power to the second wireless power receiver in the resonance mode while maintaining power transmission in the electromagnetic resonance mode to the first wireless power receiver.

18. The multiplex-mode wireless power transmitter according to claim 15, the controller terminates power transmission to the first wireless power receiver and transmits power to the second wireless power receiver in the electromagnetic induction mode.

19. The multiplex-mode wireless power transmitter according to claim 15, the controller maintains power transmission with respect to the first wireless power receiver and terminates a communication session for power transmission in the electromagnetic induction mode with respect to the second wireless power receiver.

20. The multiplex-mode wireless power transmitter according to claim 11, the controller calculates the first power transmission efficiency with respect to the first wireless power receiver while transmitting power to the first wireless power receiver.
